(19) United States
(12) Patent Application Publication
(10) Pub. No.: US 2025/0118279 A1
(43) Pub. Date: Apr. 10, 2025

(54) COMMUNICATION SYSTEMS AND METHODS FOR ADAPTING PRE-PROGRAMMED EFFECTS TO A MUSICAL PERFORMANCE

(71) Applicant: Marion Banks Camak, III, Nashville, TN (US)

(72) Inventor: Marion Banks Camak, III, Nashville, TN (US)

(21) Appl. No.: 18/906,407

(22) Filed: Oct. 4, 2024

Related U.S. Application Data
(60) Provisional application No. 63/588,127, filed on Oct. 5, 2023.

(51) Int. Cl. G10H 1/00; G10H 1/34

(52) U.S. Cl. CPC G10H 1/0066; G10H 1/0008; G10H 1/34

(57) ABSTRACT

A communication system for adapting pre-programmed effects to a musical performance includes: one or more controllers, providing a first control and a second control; one or more processors operably connected to the one or more controllers; and memory storing instructions for execution by the one or more processors. The first control can be activated and deactivated to affect an audio and/or visual output based on communications from the processor(s) during playback in a temporal grid of a digital audio workstation (DAW) program based on pre-programmed operation prompts associated with the temporal grid. The second control can be selectively engaged by a user to stop, move, and restart the playback. Communications from the processor(s) to activate and deactivate the first control based on the pre-programmed operation prompts are delayed following the restart of playback until playback reaches a trigger associated with a predetermined time point in the temporal grid.

### CROSS-REFERENCE TO RELATED APPLICATION

The present application claims priority to U.S. Patent Application Ser. No. 63/588,127 filed on Oct. 5, 2023, the entire disclosure of which is incorporated herein by reference.

### BACKGROUND

The present disclosure relates to communication systems and methods for musical performances and production. More particularly, the present disclosure relates to communication systems and methods for adapting pre-programmed effects to a musical performance.

Digital audio workstation (DAW) software can be installed on an electronic device to enable recording, editing, and production of audio files. Typically, DAW software provides: playback controls (play, rewind, record, etc.) that allow an individual to navigate within, start and stop, or record a musical composition; track controls that can be manipulated to affect parameters of the individual tracks of the composition; and mixing controls that allow the levels of respective tracks of the composition to be adjusted relative to each other. In use, the electronic device on which the DAW software is installed can be operably connected to other electronic devices as to affect the operation thereof and/or vice versa. For instance, in recent years, it has become increasingly popular to use an electronic device equipped with DAW software in conjunction with an external controller and an external output device configured to emit an analog or digital signal (e.g., an amplifier) and to program the electronic device using DAW software to selectively transmit instructions (signals) to affect the nature of the signal output by the external output device as playback of the musical composition progresses. In this regard, using DAW software, an electronic device can be programmed in a manner which effectively “maps” effects to a particular time point in a temporal grid containing meter and tempo information for the composition, such that, instead of an individual having to take manual action to apply an effect (e.g., engaging a pedal to manipulate the sound of a guitar emanating from an amplifier) at a particular time point within a composition, the DAW software will cause such effect to automatically be applied when the designated time point is reached. Using DAW software, the electronic device can be programmed to transmit instructions either directly or indirectly to the external output device. For instance, at some points during playback of a composition, the DAW software may cause the electronic device to communicate signals directly to the external output device (e.g., to increase or decrease the volume of the analog signal emitted from an amplifier), while, at other points during the playback of the composition, the DAW software may cause the electronic device to communicate signals to the external controller (e.g., to apply an effect corresponding to a pedal of a MIDI pedal board) which processes the received signals and generates additional signals that are subsequently communicated to, and affect the output emitted by, the external output device.

Problems arise, however, with the foregoing setup in instances where, during a live performance of the musical composition, an individual wishes to improvise or otherwise needs to depart from the mapped timekeeping grid within the DAW software. For instance, if an individual were to add an extra measure to the bridge of a composition before entering into the chorus that immediately follows the bridge, the settings or parameters pre-programmed with the DAW software would be one measure ahead of where the individual actually is within the composition. In other words, in the foregoing scenario, the DAW software would cause the electronic device to communicate signals which affect the output of the external output device in a manner which corresponds to the chorus of the composition as opposed to the bridge (i.e. where the individual is actually at in the live performance). Currently, to address problems like the foregoing example where an individual extends the duration of a particular part of a composition beyond the time allocated to that part of the composition within the timekeeping grid of the DAW software, an individual must manually, by either interacting with a user interface of the DAW software or by engaging the external controller, stop the playback of the composition at the precise moment at which the individual wants to improvise or otherwise affect the timing of the composition. The individual must then manually restart the playback at the precise moment during the performance which corresponds to the point of the composition where the playback was stopped so that the preprogrammed settings mapped to the timekeeping grid will be applied at the correct time during the remainder of the composition, which is not feasible if the performance demands that the individual actively play an instrument at the time the playback needs to be restarted.

Furthermore, once the playback is restarted, in known systems, the DAW software will cause the electronic device on which it is installed to immediately communicate signals to apply the same effects as were active at the time the playback was stopped, which effectively prevents individuals from improvising or otherwise departing from the mapped timekeeping grid of the DAW software in the middle of a part of the composition (e.g., the verse). For instance, if an individual were to stop the playback and begin improvising starting at measure two of a four-measure verse and continue to do so for two measures until reaching a chorus of the composition which immediately follows the verse, upon restarting the playback at the beginning of the chorus, the DAW software would cause the electronic device to communicate signals which cause the settings applied at the time the playback was stopped (i.e., at measure two of the verse) instead of the preprogrammed settings corresponding to the chorus.

Accordingly, systems and methods which enable individuals to take advantage of modern electronic musical programming techniques while also providing the flexibility for impromptu modification of a musical composition during a live performance would be both beneficial and desirable.

### SUMMARY

The present disclosure includes communication systems for adapting pre-programmed effects to a musical performance.

A communication system for adapting pre-programmed effects to a musical performance includes: one or more controllers, providing a first control and a second control; one or more processors operably connected to the one or more controllers; and memory storing instructions for execution by the one or more processors. The first control can be selectively activated to affect an audio output and/or a visual output to be emitted from an output device. In use, the one or more processors execute instructions stored on the memory to selectively communicate instructions to the one or more controllers to activate and deactivate the first control during playback in a temporal grid of a digital audio workstation (DAW) program based on pre-programmed operation prompts associated with the temporal grid.

The second control is configured to be selectively engaged by a user to regulate playback in the temporal grid. Subsequent to receiving an instruction from the one or more controllers indicative of a first engagement of the second control, the one or more processors stop playback at a first time point in the temporal grid. Subsequent to receiving an instruction from the one or more controllers indicative of a second engagement with the second control, the one or more processors move and restart playback at a second time point in the temporal grid which is different than the first time point where playback was stopped. Following the restart of playback, and upon reaching a trigger associated with a predetermined time point in the temporal grid occurring at or following the second time point where playback was moved and restarted, the one or more processors recommence selectively communicating instructions to the one or more controllers to activate and deactivate the first control during playback in the temporal grid based on the pre-programmed operation prompts.

In some embodiments, the one or more processors and the memory are components of an electronic device, such as a computer including a display for displaying one or more graphical user interfaces of the DAW program. In some embodiments, the one or more graphical user interfaces includes at least one graphical user interface which includes one or more user interface tools that enable a user to associate the trigger with the temporal grid. In some embodiments, the predetermined time point of the temporal grid with which the trigger is associated occurs after the second time point in the temporal grid where playback is moved and restarted following the second engagement of the second control.

In some embodiments, at least one of the one or more controllers is a musical digital interface (MIDI) controller. In some embodiments, at least one of the of the one or more controllers is indirectly connected to an output device via one or more MIDI-enabled devices. In some embodiments, the one or more controllers includes a controller that includes both the first control and the second control. In some embodiments the one or more controllers includes a first controller including the first control and a second controller including the second control.

Multiple communication systems made in accordance with the present disclosure can be utilized in conjunction with a control subsystem configured to synchronize playback within the respective communication systems to provide a system for adapting pre-programmed effects to a musical performance involving multiple individuals playing the same musical composition.

Methods for adapting pre-programmed effects to a musical performance are also disclosed.

### BRIEF DESCRIPTION OF THE DRAWINGS

FIG. 1 is a diagram of a communication system for adapting pre-programmed effects to a musical performance made in accordance with the present disclosure;

FIG. 2 is an example graphical user interface of a digital audio workstation (DAW) program, including a temporal grid, presented on a display of an electronic device of the communication system of FIG. 1;

FIG. 3 is a diagram of an exemplary embodiment a communication system for adapting pre-programmed effects to a musical performance made in accordance with the present disclosure;

FIG. 4 is an example graphical user interface of a DAW program, including a temporal grid, presented on a display of a computer of the exemplary communication system of FIG. 3;

FIG. 5 is a flow diagram showing an exemplary method for adapting pre-programmed effects to a musical performance;

FIG. 6A is another example graphical user interface of the DAW program presented on the display of the computer of the exemplary communication system of FIG. 3, with a first user tool of the graphical user interface selected;

FIG. 6B is the example graphical user interface of FIG. 6A, but with a second user tool of the graphical user interface selected;

FIG. 6C is the example graphical user interface of FIG. 6A, but with a third user tool of the graphical user interface selected;

FIG. 7 is a diagram of another exemplary embodiment of a communication system for adapting pre-programmed effects made in accordance with the present disclosure;

FIG. 8 is another exemplary embodiment of a communication system for adapting pre-programmed effects to a musical performance made in accordance with the present disclosure; and

FIG. 9 is a diagram of another exemplary communication system for adapting pre-programmed effects to a musical performance made in accordance with the present disclosure.

### DESCRIPTION OF EXEMPLARY EMBODIMENTS

The present disclosure includes communication systems and methods for adapting pre-programmed effects to a musical performance. In particular, the present disclosure includes communication systems and methods for adapting the application of pre-programmed effects for a musical composition associated with a temporal grid of a digital audio workstation (DAW) program to a temporally or compositionally different live performance of the musical composition.

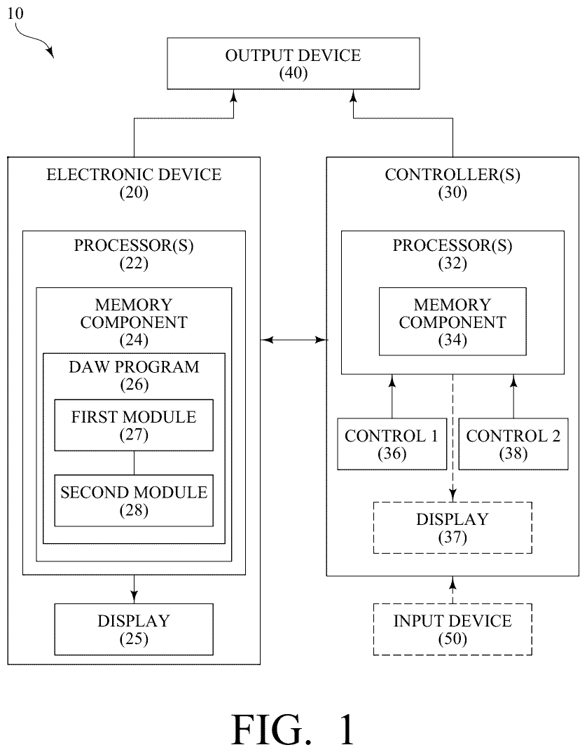

Referring first to FIG. 1, a communication system for adapting pre-programmed effects to a musical performance 10 (or communication system 10) made in accordance with the present disclosure generally includes: an electronic device 20; and one or more controllers 30 operably connected to the electronic device 20, such that instructions (signals) can be communicated between the electronic device 20 and the one or more controllers 30 to affect the operation of such components, as further described below. In use, the communication system 10 can be utilized during a live performance of a musical composition to selectively and autonomously carry out pre-programmed operations to affect an audio and/or visual output generated during the live performance, such as the sounds produced by an individual playing a musical instrument or the light emitted from a stage light. As will become evident in the description that follows, the application of such pre-programmed operations can, however, be regulated, at least in part, by user engagement with the one or more controllers 30 to accommodate periods of improvisation, or other periods during the live performance where the application of the pre-programmed operations is not necessary or desired.

Referring still to FIG. 1, each controller of the one or more controllers 30 can be selectively manipulated to affect (i) an audio output and/or a visual output to be emitted by an output device 40 to which the controller is operably connected, and/or (ii) the operation of the electronic device 20. Accordingly, in some embodiments, the communication system 10 may further include an output device 40 that is configured to emit an audio and/or visual output. The output device 40 may be operably connected to the one or more controllers 30 via a direct connection or an indirect connection, via one or more intermediate devices, such that the one or more controllers 30 can: (i) manipulate an audio signal and/or visual signal directed to the output device 40, prior to such signal(s) actually reaching the output device 40 to affect the audio and/or visual output ultimately emitted from the output device 40; and/or (ii) communicate instructions (signals) to the output device 40 which affect the operation of the output device 40 in a manner which affects the audio and/or visual output emitted therefrom (e.g., instructions which adjust the volume controls or parameters of the output device 40 to make the audio emitted therefrom louder or quieter).

Referring still to FIG. 1, as shown, the one or more controllers 30 provide a first control 36 and a second control 38. The first control 36 is configured to be selectively activated to affect the audio output and/or the visual output to be emitted by the output device 40 by modulating or otherwise manipulating an audio and/or visual input signal prior to such signal being communicated to the output device 40 and/or by communicating instructions which affect the operation of the output device 40 (e.g., adjusting the volume controls or parameters of the output device 40 or activating one or more effects pre-programmed in the output device 40). As activation of the first control 36 changes the audio output and/or the visual output ultimately emitted from the output device 40 relative to what the output would be absent activation of the first control 36, the activation of the first control 36 may also be characterized as “applying one or more effects associated with the first control 36” to the audio output and/or the visual output ultimately emitted by the output device 40. In this regard, the first control 36 may also be characterized as an “effect control.” In some embodiments and implementations, the input audio and/or visual input signal may be generated by an external input device 50 that is operably connected to the one or more controllers 30. In some embodiments and implementations, the external input device 50 may comprise a musical device, such as a musical instrument or microphone, configured to generate an input audio signal in response to user interaction with the musical device. In some embodiments, the external input device 50 may be directly connected to a controller including the first control 36 or indirectly to the controller including the first control 36 via one or more intermediate devices. Accordingly, in some embodiments, the communication system 10 may further include an external input device 50. Alternatively, the input signal affected by activation of the first control 36 may be generated by a controller of the one or more controllers 30 or by the electronic device 20.

Referring still to FIG. 1, the second control 38 is configured to be selectively engaged by a user to initiate the communication of instructions (signals) to the one or more processors 22 of the electronic device 20, the importance of which is described below.

Referring still to FIG. 1, the communication system 10 can, in some embodiments, include a single controller 30 which includes both the first control 36 and the second control 38. In such embodiments, the controller 30 is operably connected to the electronic device 20, such that: (i) the electronic device 20 can communicate instructions (signals) to the controller 30 which cause the first control 36 to be activated to apply one or more effects associated with the first control 36 and deactivated to prevent the first control 36 from affecting the audio output and/or the visual output to be emitted from the output device 40; and (ii) the controller 30 can communicate instructions (signals) to the electronic device 20 in response to the second control 38 being engaged by the user. To facilitate the activation and deactivation of the first control 36 in response to communications from the electronic device 20 and the communication of instructions to the electronic device 20 as a result of user engagement of the second control 38, the controller 30 includes a processor 32 and a memory component 34. The processor 32 is operably connected to the first control 36 and the second control 38, and is configured to execute instructions (routines) stored in the memory component 34 or other computer-readable medium to perform the various operations of the controller 30 described herein.

It is appreciated however that, in some embodiments, the communication system 10 can include two or more separate controllers, with one controller including the first control 36 and another controller including the second control 38 without departing from the spirit and scope of the present disclosure. In such embodiments, the controller including the first control 36 would be operably connected to the electronic device 20 in a manner which facilitates at least the communication of instructions which activate and deactivate the first control 36 from the electronic device 20 to the controller including the first control 36. Further, in such embodiments, the controller including the second control 38 would be operably connected to the electronic device 20 in a manner which facilitates at least the communication of instructions affecting certain operations of the electronic device 20 described below from the controller including the second control 38 to the electronic device 20. In embodiments including multiple controllers, each respective controller may include a processor and a memory component or other computer-readable medium including instructions for execution by the processor. Accordingly, while the one or more controllers 30 of the communication system 10 described herein with reference to FIG. 1 is sometimes referred to in singular form for ease of explanation, it is appreciated that the communication system 10 is not necessarily limited to a single controller configuration.

Referring still to FIG. 1, the electronic device 20 includes one or more processors 22 and a memory component 24 or other computer-readable medium which is operably connected to the one or more processors 22 and includes instructions, which, when executed by the one or more processors 22, cause the one or more processors 22 to perform various operations of the electronic device 20 described herein. Except where context precludes otherwise, it should be appreciated that where reference is made to the electronic device 20 carrying out an operation that such operation is achieved by virtue of the one or more processors 22 of the electronic device 20 executing instructions stored on the memory component 24 or other computer-readable medium operably connected to the one or more processors 22. Furthermore, and again, except where context precludes otherwise, it should be appreciated that where reference is made to the electronic device 20 being operably connected to another component, such connection refers to a connection in which instructions (signals) can be communicated from the one or more processors 22 of the electronic device 20 to such component and/or a connection in which instructions (signals) can be communicated from such component to the one or more processors 22 of the electronic device 20. Except where context precludes otherwise, such connection may be facilitated by wired and/or wireless connection means that are well-known within the art.

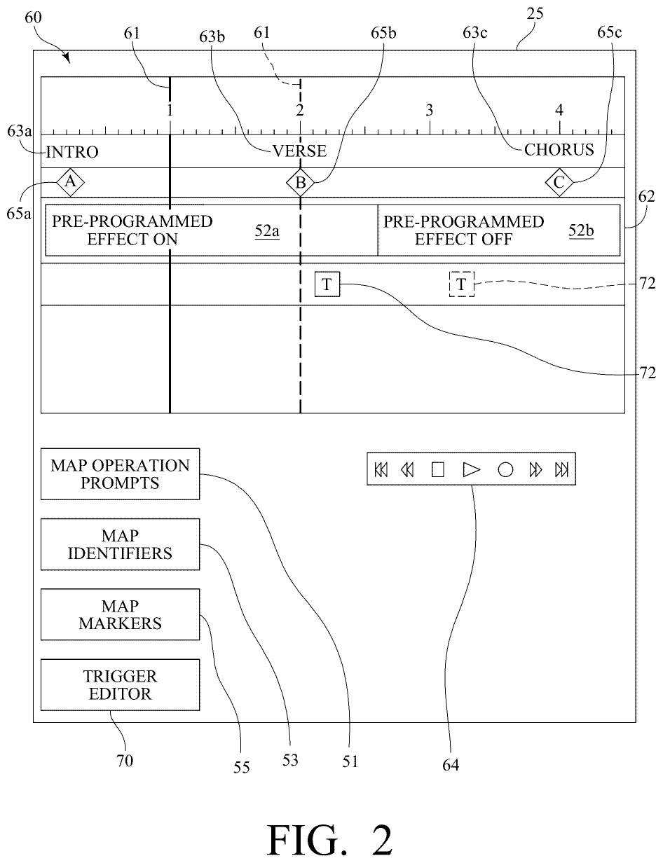

Referring now to FIGS. 1 and 2, a DAW program 26 is stored in the memory component 24 or other computer-readable medium of the electronic device 20 and includes instructions, which, when executed by the one or more processors 22 of the electronic device 20, enable a user to, by interacting with a graphical user interface 60 provided by execution of the DAW program 26 (i.e., a graphical user interface 60 associated with the DAW program 26), associate a musical composition with a temporal grid 62 (i.e., associate each part of the musical composition with a series of timestamps) provided by the DAW program 26. In some implementations, where the musical composition is already developed, associating the musical composition with the temporal grid 62 may involve uploading one or more files, such as an mp3, .mp4, or .wav files, containing the musical composition to the electronic device 20 and associating such files with the temporal grid 62. Additionally or alternatively, associating the musical composition with the temporal grid 62 may involve associating identifiers 63a, 63b, 63c corresponding to different parts of the musical composition with the temporal grid 62, as further discussed below. As shown, to facilitate display of user interfaces associated with the DAW program 26, the electronic device 20 can further include a display 25 that is operably connected to the one or more processors 22.

Referring still to FIGS. 1 and 2, the DAW program 26 also includes instructions, which, when executed by the one or more processors 22 of the electronic device 20, enable the user to, by interacting with the graphical user interface 60, elect and apply (or map) operation prompts 52a, 52b for the musical composition at different time points along the temporal grid 62 which cause the electronic device 20 to carry out certain operations. Specifically, the user can interact with the graphical user interface 60 to map operation prompts 52a, 52b corresponding to the activation and deactivation of the first control 36 at different time points along the temporal grid 62. As shown in FIG. 1, the electronic device 20 can, in some embodiments, also be operably connected to the output device 40, such that the electronic device 20 can communicate instructions (signals) directly to the output device 40 to affect various parameters of the audio output and/or visual output to be emitted thereby, such as the volume of the audio output or the amount of light emitted in the visual output. Accordingly, in such embodiments, the DAW program 26 also permits the mapping of additional operation prompts (not shown) at different time points along the temporal grid 62 which cause the electronic device 20 to communicate certain instructions (signals) directly to the output device 40 to affect the operation thereof.

Referring now specifically to FIG. 2, to facilitate the mapping of operation prompts 52a, 52b corresponding to the first control 36 or operation prompts corresponding to the output device 40 along the temporal grid 62, the graphical user interface 60 includes one or more operation mapping tools 51 with which the user can interact to map such operation prompts along the temporal grid 62 in a manner consistent with that known in the art; see, e.g., Avid Technology, Inc., Pro Tools® Reference Guide Version 12.8.2 (2017) available at https://resources.avid.com/SupportFiles/PT/Pro_Tools_Reference_Guide_12.8.2.pdf, which is incorporated herein in its entirety by reference.

Referring now again to FIGS. 1 and 2, once the temporal grid 62 is mapped with operation prompts 52a, 52b corresponding to activation and deactivation of the first control 36, playback controls 64 provided in the graphical user interface 60 can be engaged to commence playback in the mapped temporal grid 62 on the electronic device 20 during a live performance of the musical composition. As the point of playback 61 proceeds through the temporal grid 62 and reaches a time point with one or more operation prompts 52a, 52b associated therewith, the electronic device 20 will perform the operation(s) corresponding to such operation prompts. For instance, upon the point of playback 61 reaching a time point with an operation prompt 52a corresponding to the activation of the first control 36 or an operation prompt 52b corresponding to deactivation of the first control 36, the electronic device 20 will communicate instructions (signals) to the controller 30 which cause the first control 36 to be activated or deactivated, respectively. As shown, in some implementations the operation prompts 52a, 52b may span across multiple time points in the temporal grid 62, such that, if playback is moved within the temporal grid 62 past the time point where an operation prompt 52a, 52b initially occurs within the temporal grid 62, the electronic device 20 can still discern whether the first control 36 should be activated or deactivated at the time point where playback was moved to. In instances where the input signal is generated by virtue of an external input device 50, such as a musical instrument played by the user during the live performance, upon the point of playback 61 reaching an operation prompt 52a corresponding to activation of the first control 36, the electronic device 20 will communicate instructions which activate the first control 36. As a result of the first control 36 being activated, the input signal generated by the user playing the musical instrument will be manipulated and/or the operation of the output device 40 will be affected (e.g., adjusting the volume or applying one or effects programmed into the output device 40) to alter the sound emitted from the output device 40 corresponding to the user's playing of the musical instrument. In this way, the DAW program 26 enables the electronic device 20 to be pre-programmed, such that the playback controls 64 provided by the DAW program 26 can be engaged to effectively provide autonomous operation of the first control 36 to apply the one or more effects provided by activation thereof and/or provide autonomous operation of the output device 40 during the course of a live performance of the musical composition, thus leaving the individual free to engage in other activities associated with the performance.

Referring still to FIGS. 1 and 2, playback of the musical composition associated with the temporal grid 62 on the electronic device 20 can be stopped and the point of playback 61 subsequently moved in response to user engagement with the second control 38. In this regard, the second control 38 of the controller 30 can be selectively engaged by the user to communicate instructions (or signals) to the electronic device 20 which cause the electronic device 20 to stop playback of the musical composition associated with the temporal grid 62 at a first time point in the temporal grid 62 (as indicated by the solid-line representation of the point of playback in FIG. 2). While the playback is stopped, the operations corresponding to the operation prompts 52a, 52b associated with the temporal grid 62 will not be executed by the electronic device 20, thus creating a period during the live performance where the user can freely improvise without the first control 36 being autonomously activated and deactivated. During this period, the user can modify the musical composition during the live performance relative to the musical composition as associated with the temporal grid 62 on the electronic device 20, for example, by extending or shortening a particular part of the musical composition and/or by playing different material at a particular part of the musical composition than that which the operation prompts 52a, 52b were initially mapped based on.

Referring still to FIGS. 1 and 2, in addition to stopping playback of the musical composition associated with the temporal grid 62, in some embodiments and implementations, the electronic device 20 may also communicate instructions (signals) which deactivate the first control 36 in response to the user engaging the second control 38 at the same time playback is stopped. In some embodiments, the controller with which the first control 36 is associated may permit activation and deactivation of the first control 36 via manual user engagement with the first control 36 while playback of the musical composition associated within the temporal grid 62 is stopped on the electronic device 20 and the operations corresponding to the operation prompts 52a, 52b associated with the temporal grid 62 are not being executed. Thus, in such embodiments, during a period between the time at which playback of the musical composition associated with the temporal grid 62 is stopped and the time at which playback of the musical composition associated with the temporal grid 62 is restarted on the electronic device 20, the user can selectively manually engage the first control 36 to selectively activate and deactivate the first control 36 and apply the one or more effects associated therewith. It should thus be clear that “activation” of the first control 36 does not refer to a state in which the first control 36 or the controller in which the first control 36 is included is rendered operable, but, rather, to a state in which the controller including the first control 36 causes the one or more effects associated with the first control 36 to be applied. Likewise, it should thus also be clear that “deactivation” of the first control 36 does not refer to a state in which the first control 36 or the controller in which the first control 36 is included is rendered inoperable, but, rather, to a state in which the controller including the first control 36 is not causing the one or more effects associated with the first control 36 to be applied.

Referring still to FIGS. 1 and 2, the second control 38 can also be engaged after playback of the musical composition associated with the temporal grid 62 has been stopped to restart playback of the musical composition associated with the temporal grid 62 on the electronic device 20. In this regard, a user can thus engage the second control 38 at a first time (i.e., the user can have a first engagement with the second control 38) to stop playback of the musical composition at a first time point in the temporal grid 62, as shown by the solid point of playback 61 in FIG. 2. Then, the user can later engage the second control 38 at a second time (i.e., the user can have a second engagement with the second control 38) to restart playback of the musical composition after a period of improvisation. In this regard, the controller 30 is operably connected to the electronic device 20, such that the controller 30 can transmit playback deactivation instructions (signals) which stop playback and playback activation instructions (signals) which move and restart playback of the musical composition associated with temporal grid 62 on the electronic device 20 based on user engagement with the second control 38. In some embodiments, the second control 38 is configured to cycle between communicating deactivation instructions and activation instructions to the electronic device 20 as the second control 38 is iteratively engaged by the user. For instance, in such embodiments, in response to a first, second, third, and fourth engagement of the second control 38, the controller 30 may communicate playback deactivation, playback activation, playback deactivation, and playback activation instructions, respectively, to the electronic device 20.

Referring still to FIGS. 1 and 2, instead of restarting the playback at the first time in the temporal grid 62 where the playback was initially stopped, in response to the user's second engagement of the second control 38, the point of playback 61 is automatically moved (or shifted) by the electronic device 20 to a pre-determined second time point in the temporal grid 62 that is different from where playback was stopped, as shown by the broken-line representation of the point of playback 61 in FIG. 2. Specifically, the point of playback 61 is moved to and playback is restarted by the electronic device 20 at a time point within the temporal grid 62 corresponding to one of a series of markers 65a, 65b, 65c associated with different time points along the temporal grid 62 following the user's second engagement with the second control 38. The markers 65a, 65b, 65c can be set at different time points along the temporal grid 62 in a manner consistent with that known within the art. In this regard, the markers 65a, 65b, 65c can be set at different time points along the temporal grid 62 via user interaction with one or more marker mapping tools 55 within a graphical user interface 60 provided by execution of the DAW program 26 and provided on the display 25 of the electronic device 20.

Referring still to FIGS. 1 and 2, prior to a live performance, the user can set one or more markers 65a, 65b, 65c at select time points along the temporal grid 62 corresponding to portions of the musical composition where the user is likely to be or may want to go to in the live performance of the musical composition following a period of improvisation (i.e., a period in which playback was stopped as a result of the user's engagement with the second control 38). For instance, in some implementations, the user may anticipate it to be beneficial to move the point of playback 61 to and restart playback at a time point in the temporal grid 62 which follows a time point within the temporal grid 62 where the user anticipates stopping playback to establish a period of improvisation (as shown by the solid-line representation of the point of playback 61 in FIG. 2). Then, during the live performance, after engaging the second control 38 a first time to stop playback to establish a period of improvisation, the user can re-engage the second control 38 to align the point of playback 61 and restart playback at a marker 65a, 65b, 65c (as shown by the broken-line representation of the point of playback 61 in FIG. 2) associated with a time point in the temporal grid 62 which better corresponds to the part of the musical composition the user is actually at or would like to go to in the live performance following the period of improvisation. In turn, the operations executed by the electronic device 20 affecting activation and deactivation of the first control 36 based on the pre-programmed operation prompts 52a, 52b associated with the temporal grid 62 will thus also better correspond to the part of the musical composition where the user is actually at or wants to go in in the live performance as a result of moving the point of playback 61 and restarting playback in the foregoing manner. Accordingly, by moving the point of playback 61 and restarting playback in response to user engagement with the second control 38 in this way, the communication system 10 effectively adapts the pre-programmed effects corresponding to the pre-programmed operation prompts 52a, 52b within the temporal grid 62 of the DAW program 26 to the live performance of the musical composition based on the user's engagement with the second control 38, instead of simply recommencing playback and applying any applicable pre-programmed effects at the time point where playback was stopped.

Referring still to FIGS. 1 and 2, the markers 65a, 65b, 65c to which the point of playback can be moved following the user's second engagement of the second control 38 can be provided at substantially the same time points along the temporal grid 62 as identifiers 63a, 63b, 63c provided along the temporal grid 62 that correspond to the beginning different parts of the musical composition (e.g., the intro, verse, chorus, bridge, etc.). With such marker-identifier arrangement, a user can engage the second control 38 following a period of improvisation in which playback is stopped to advance the point of playback 61 and restart playback at a different part of the musical composition than the part of the musical composition where playback was initially stopped to provide the period of improvisation. Similar to the markers 65a, 65b, 65c, the identifiers 63a, 63b, 63c will also typically be set along the temporal grid 62 via user interaction with one or more identifier mapping tools 53 within a graphical user interface 60 provided by execution of the DAW program 26 and provided on the display 25 of the electronic device 20 in a manner which is well-known within the art.

While it may prove useful for the identifiers 63a, 63b, 63c and the markers 65a, 65b, 65c to correspond to the same time points along the temporal grid 62 so that the point of playback 61 can be moved to a different part of the musical composition following a period of improvisation where playback in the temporal grid 62 is stopped, it is not required. Rather, each marker 65a, 65b, 65c can be associated with a time point in the temporal grid 62 which occurs: before an identifier 63a, 63b, 63c; after an identifier 63a, 63b, 63c; or between multiple identifiers 63a, 63b, 63c so that the point of playback 61 can be moved to time points along the temporal grid 62 which do not perfectly align with the beginning of a part of the musical composition without departing from the spirit and scope of the present disclosure.

Referring now again to FIGS. 1 and 2, selection of the specific marker 65a, 65b, 65c to which the point of playback 61 is moved to and playback restarted at in the temporal grid 62 in response to the user's second engagement with the second control 38 can be based, in some embodiments and implementations, on pre-programmed instructions stored in the memory component 24 or other computer-readable medium of the electronic device 20. For instance, in some embodiments and implementations, the DAW program 26 may include instructions, which, when executed, cause the one or more processors 22 of the electronic device 20, subsequent to the user's second engagement with the second control 38, to move and restart playback at: (i) a time point in the temporal grid 62 corresponding to the first marker 65a, 65b, 65c following the time point in the temporal grid 62 where playback was stopped (i.e., the next, later-in-time marker); or (ii) a time point in the temporal grid 62 corresponding to the first marker 65a, 65b, 65c preceding the time point in the temporal grid 62 where playback was stopped (i.e., the first earlier-in-time marker).

Referring still to FIGS. 1 and 2, in some embodiments and implementations, the specific marker 65a, 65b, 65c to which the point of playback 61 is moved to and playback is restarted at may be based on user engagement with the controller 30. In this regard, and as shown in FIG. 1, the controller 30 can optionally include a display 37 for displaying the different marker 65a, 65b, 65c options and a third control (not shown) with which the user can engage to select which marker 65a, 65b, 65c the point of playback 61 should be moved and playback restarted at subsequent to the user's second engagement with the second control 38 and communicate such selection to the electronic device 20. In this way, the user can thus control the positioning of the point of playback 61 within the temporal grid without having to physically engage the electronic device 20 executing the DAW program 26. In such embodiments, the display 37 is operably connected to the processor 32 of the controller 30, and the electronic device 20 is configured to communicate marker information to the controller 30 for subsequent display thereon. Further, in such embodiments, the third control would be operably connected to the processor 32 of the controller 30 and the controller 30 configured to communicate the user's marker selection to the electronic device 20 for subsequent processing.

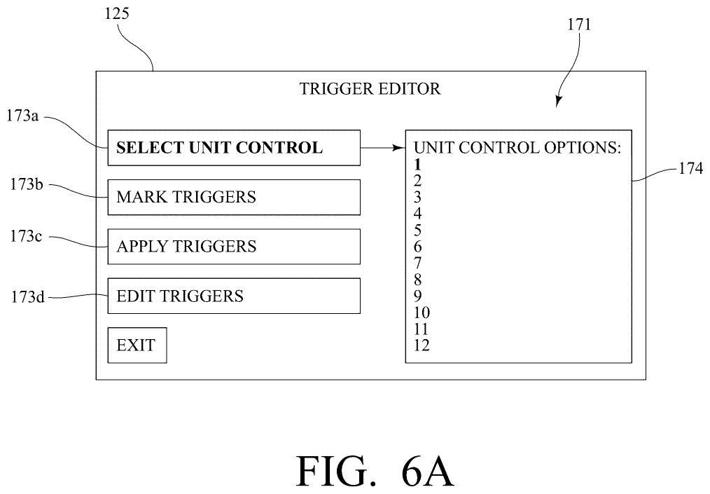

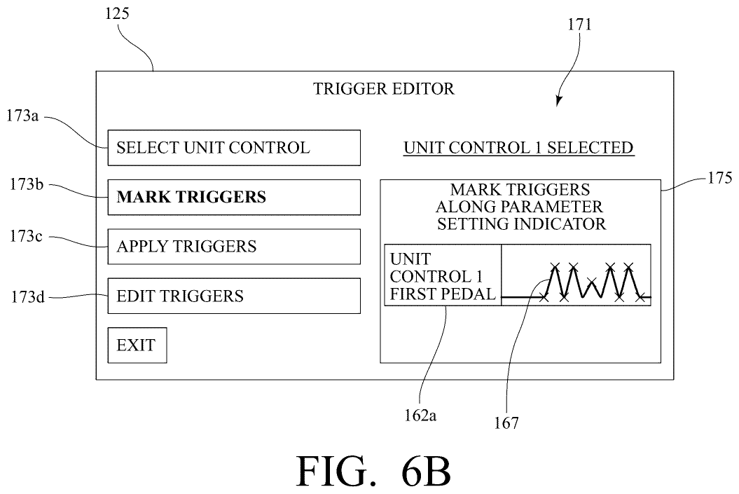

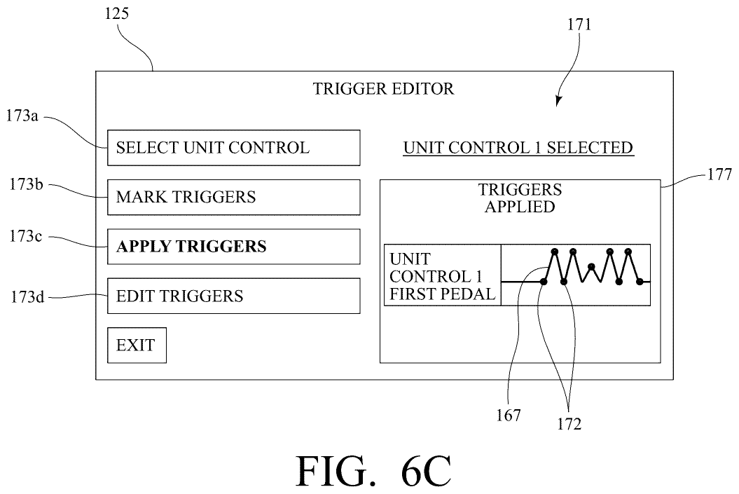

Referring still to FIGS. 1 and 2, instead of the electronic device 20 immediately executing operations corresponding to pre-programmed operation prompts 52a, 52b associated with the temporal grid 62 at the point in the temporal grid 62 where the point of playback 61 is moved and playback is restarted as a result of the user's second engagement with the second control 38, the DAW program 26 includes instructions which cause the execution of such operations to be conditioned upon the point of playback 61 reaching a trigger 72 associated with the temporal grid 62 following the restart of playback. In some implementations, multiple triggers 72 may be associated with the temporal grid 62 to account for the different time points along the temporal grid 62 where playback may be restarted following a period of improvisation. Each trigger 72 associated with the temporal grid 62 is thus an indicator, which, when reached by the point of playback 61, causes the electronic device 20 to recommence selectively communicating instructions to activate and deactivate the first control 36 based on the pre-programmed operation prompts 52a, 52b associated with the temporal grid 62. In this regard, each trigger 72 associated with the temporal grid 72 may also be characterized as an “activation node.” As further discussed below with reference to FIGS. 6A-6C, the triggers 72 associated with the temporal grid 62 can be implemented through user engagement with one or more trigger implementation tools 70 associated with a graphical user interface provided by execution of the DAW program 26. In some embodiments and implementations, triggers 72 can be associated with the temporal grid 72 in the same or similar manner as the operation prompts 52a, 52b.

Referring still to FIGS. 1 and 2, a user can thus strategically implement triggers 72 at select time points throughout the temporal grid 62 relative to the markers 65a, 65b, 65c to which playback can be moved to and restarted to create delays between the time playback is restarted and when the electronic device 20 will actually recommence selectively activating and deactivating the first control 36, as is evidenced, for example, by the difference in time points along the temporal grid 62 in which the broken-line representation of the point of playback 61 and the solid-line representation of the trigger 72 occur in FIG. 2. Such delays may prove advantageous, for example, in instances where the user needs to adjust certain settings of the electronic device 20, the controller 30, the output device 40, and/or input device 50 following a period of improvisation.

Referring still to FIGS. 1 and 2, triggers 72 can also be implemented along the temporal grid 62 in a manner which effectively negates the operations corresponding to certain pre-programmed operation prompts 52a, 52b following a period of improvisation, even in situations where playback is recommenced at the point in the temporal grid 62 where such operations would normally occur. Selectively negating certain operations corresponding to select operation prompts 52a, 52b may prove advantageous, for example, where the user would like to provide a live performance where the activation or deactivation of the first control 36 is altered relative to that mapped within the temporal grid 62. For instance, and referring now specifically to FIG. 2, instead of setting the trigger 72 at a time point where there is an operation prompt 52a corresponding to activation of the first control 36, the user can set the trigger 72 at a time point where there is an operation prompt 52b corresponding to deactivation of the first control 36 (as indicated by the broken-line representation of trigger 72). Accordingly, during the period between the time point in the temporal grid 62 where playback is recommenced (as evidenced by the broken line representation of the point of playback 61) and the time point where the broken-line representation of the trigger 72 occurs, the electronic device 20 will not autonomously activate the first control 36. Instead, the user can selectively engage the first control 36 during a live performance during such period to selectively apply the one or more effects associated with the first control 36 and affect the audio output and/or visual output emitted from the output device 40.

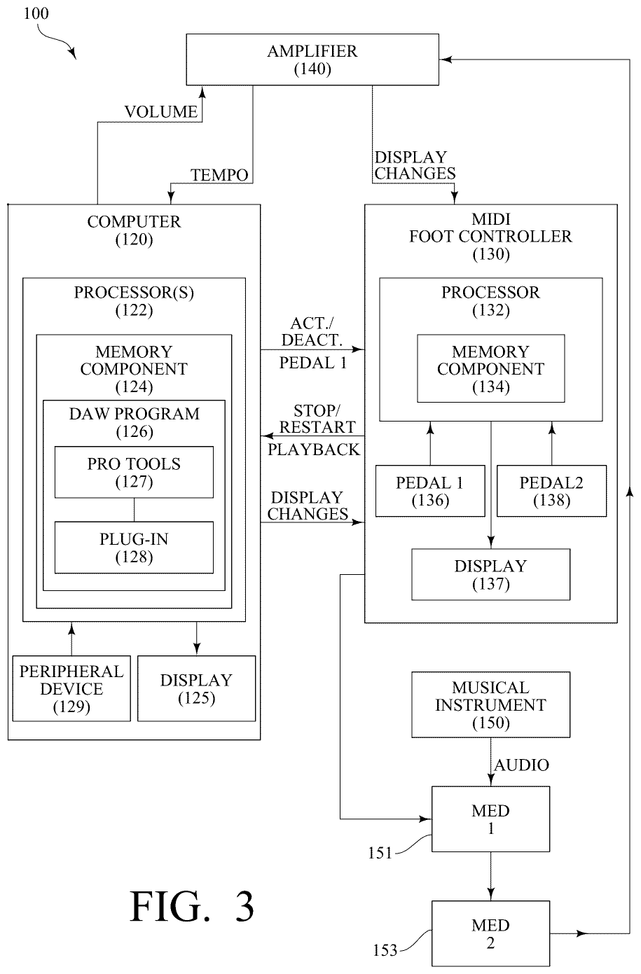

As will become evident by the discussion which follows, and, in particular to the discussion regarding certain exemplary embodiments and implementations of the communication system with reference to FIGS. 3, 7, and 8, a variety of different electronic devices 20, controllers 30, output devices 40, and/or input devices 50 and system component arrangements may be utilized within the communication system 10 while still enabling the communication system 10 to carry out the above-described operations and without departing from the spirit and scope of the present disclosure. Accordingly, while reference is sometimes made to certain exemplary embodiments and implementations of the communication system 10, it should be appreciated that the communication system 10 is not necessarily limited to a system arrangement including the specific components and arrangements referred to in such exemplary embodiments and implementations.

In some embodiments, the output device 40 may comprise a speaker, amplifier, or other device configured to emit sound based on a received audio signal. In some embodiments, the output device 40 is a MIDI-enabled device which can receive instructions in the form of MIDI data from a controller including the first control 36 to affect the operation of the output device 40, e.g., by adjusting the output volume of the output device and/or applying one or more pre-programmed effects associated with the output device. One such output device is the Diezel Herbert amplifier manufactured by Diezel GmbH of Bad Steben, Germany.

In embodiments including an external input device 50 for generating an input audio signal that is subsequently manipulated by the communication system 10 prior to being emitted from the output device 40, the external input device 50 may comprise a musical instrument, such as a guitar, that generates an audio signal in response to a user playing the musical instrument, or a microphone that generates an audio signal in response to a user singing into the microphone.

In some embodiments, the electronic device 20 may comprise a computing device, such as a desktop computer, a laptop computer, a smart phone, or a tablet computer, or any other electronic device which includes one or more processors and is suitable for executing instructions associated with a memory component or other computer-readable medium to perform the operations of the electronic device 20 described herein. Although not shown, the electronic device 20 may include one or more peripheral input devices (keyboard, mouse, etc.) which enable an individual to engage with and make selections on a user interface provided on the display 25. Additionally or alternatively, in some embodiments, the display 25 of the electronic device 20 may be a touch-screen display configured to both display and enable the user to engage and make selections with a user interface displayed thereon.

Referring now again to FIGS. 1 and 2, in some embodiments, the DAW program 26 can include a first software module 27 and a second software module 28. In some embodiments and implementations, the first software module 27 may include programming instructions which, when executed by the one or more processors 22 of the electronic device 20, facilitate the initial association of the musical composition with the temporal grid 62, and mapping of the operation prompts 52a, 52b, identifiers 63a, 63b, 63c, and/or markers 65a, 65b, 65c onto the temporal grid 62. The second software module 28 works in conjunction with, and adds functionality to the first software module 27, and, in this regard, may be characterized as a “plug-in” for the first software module 27. Specifically, in this exemplary embodiment, the second software module 28 includes programming instructions, which, when executed by the one or more processors 22 of the electronic device 20, facilitate movement of playback within the temporal grid 62 based on user engagement with the second control 38, manipulation of the temporal grid 62 (e.g., the implementation of triggers 72 in to the temporal grid 62), and delays in execution of the operations corresponding to pre-programmed operation prompts 52a, 52b based on triggers 72 within the temporal grid 62 in a manner which is not contemplated or facilitated by the first software module 27. In some embodiments, the first software module 27 may comprise commercially available DAW software, such as Pro Tools®, Ableton live, ACID Pro, Audacity, Logic Pro, GarageBand®, and the like. Of course, in alternative embodiments, the DAW program 26 may be embodied as a single software module without departing from the spirit and scope of the present disclosure.

As noted, the DAW program 26 may be stored on a memory component 24 or other computer-readable medium. Generally speaking, a computer-readable medium which may be used to store the DAW program 26 can include any tangible or non-transitory storage media or memory media such as electronic, magnetic, or optical media. The term “non-transitory,” as used herein, is intended to describe a computer-readable storage medium (or “memory”) excluding propagating electromagnetic signals, but are not intended to otherwise limit the type of physical computer-readable storage device that is encompassed by the phrase computer-readable medium or memory. For instance, the term “non-transitory computer-readable medium” is intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In some embodiments, the controller 30 may be a musical instrument digital interface (MIDI) controller that is configured to generate and send MIDI data to other MIDI-enabled devices with which the controller 30 is operably connected to the controller 30. Common MIDI controllers known within the art which may be utilized in various embodiments as the controller 30 include MIDI keyboard controllers, MIDI drum controllers, and MIDI pedalboard controllers. Depending on the nature of the MIDI controller utilized, the controller 30 may be directly or indirectly connected to the output device 40. In some embodiments, the MIDI controller may be configured to generate audio signals, in addition to MIDI data.

FIG. 3 is a diagram showing a first exemplary embodiment of the communication system 10 of FIG. 1. As shown, in this exemplary embodiment, the communication system 100 includes: a computer 120, such as a laptop or desktop computer; a foot controller 130; an amplifier 140; and a musical instrument 150 which generates audio signals in response to being played. In use, the computer 120, the foot controller 130, the amplifier 140, and the musical instrument 150 provide the features and functionalities of the electronic device 20, the one or more controllers 30, the output device 40, and the external input device 50, respectively, described above with reference to FIG. 1.

Referring still to FIG. 3, the computer 120 includes one or more processors 122 for executing the instructions of a DAW program 126 stored in a memory component 124 or other computer-readable medium operably connected to the one or more processors 122 of the computer 120. As shown, in this exemplary embodiment, the first software module 127 of the DAW program 26 comprises Pro Tools®, such as Pro Tools® version 12.8.3 and the second software module 128 comprises a plug-in consistent with that of the second software module 28 described above with reference to FIG. 1. In this exemplary embodiment, the computer 120 also includes a display 125 and one or more peripheral devices 129, such as a keyboard and a mouse. The display 125 is operably connected to the one or more processors 122 and is configured to display user interfaces provided by execution of the DAW program 126 by the one or more processors 122. The one or more peripheral devices 129 are operably connected to the one or more processors 122 and enable users to engage with and make selections in user interfaces associated with the DAW program 126.

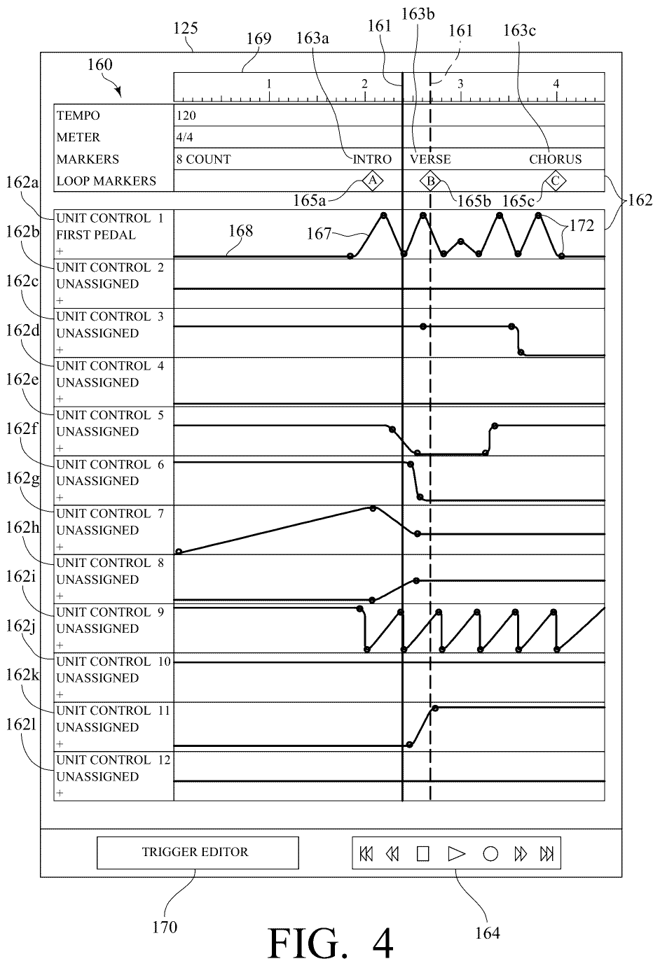

Referring still to FIG. 3, in this exemplary embodiment, the one or more controllers of the communication system 100 comprise a single foot controller 130. Specifically, in this exemplary embodiment, the foot controller 130 is a MIDI foot controller (or MIDI pedalboard). One suitable foot controller which may be utilized in the communication system 10 is the MFC-101 Mark III MIDI Foot Controller manufactured and distributed by Fractal Audio Systems, LLC of Plaistow, New Hampshire. As such, in this exemplary embodiment, the first control for affecting the output to be emitted by the amplifier 140 and the second control for regulating playback of a musical composition associated with a temporal grid 162 (FIG. 4) correspond to a first pedal 136 and a second pedal 138, respectively.

Referring still to FIG. 3, in use, the first pedal 136 can be selectively activated to cause the foot controller 130 to apply one or more effects associated with the first pedal 136 to an audio signal prior to the audio signal being received by the amplifier 140. The first pedal 136 can be selectively activated either (i) autonomously by the computer 120 based on pre-programmed operation prompts associated with the temporal grid 162 (FIG. 4) or (ii) manually by the user by stepping on or otherwise depressing the first pedal 136. In use, the second pedal 138 can be selectively engaged by the user by stepping on or otherwise depressing the second pedal 138 to regulate playback of the musical composition associated with the temporal grid 162 on the computer 120. As shown, in this exemplary embodiment, the foot controller 130 includes a processor 132 configured to execute instructions stored on a memory component 134 or other computer-readable medium operably connected to the processor 132 to perform the various operations of the foot controller 130 described herein. The foot controller 130 is operably connected to the computer 120, such that the computer 120 can communicate instructions (signals) to the foot controller 130 which cause the first pedal 136 to be activated and deactivated, and the foot controller 130 can communicate instructions (signals) to the computer 120 to regulate playback of the musical composition associated with a temporal grid 162 (FIG. 4). In this exemplary embodiment, the foot controller 130 further includes a display 137 that is operably connected to the processor 132 and configured to display visual indicia indicating the state of the first pedal 136 and/or the second pedal 138 or information received from the computer 120 and/or amplifier 140.

Referring still to FIG. 3, in this exemplary embodiment, the communication system 100 includes one or more MIDI-enabled devices 151, 153, such as one or more MIDI-enabled guitar pedals known and readily available within the art. As shown, the MIDI-enabled guitar pedals indirectly connect the musical instrument 150 to the amplifier 140, such that an audio signal generated in response to the musical instrument 150 being played is directed through the one or more MIDI-enabled devices 151, 153 prior to being received by the amplifier 140. Specifically, in this exemplary embodiment the communication system 100 includes a first MIDI-enabled device 151 and a second MIDI-enabled device 153. The first MIDI-enabled device 151 and the second MIDI-enabled device 153 each have an effect associated therewith that can be applied to manipulate the audio signal generated from the musical instrument 150 prior to reaching the amplifier 140. Application of the effect associated with the first MIDI-enabled device 151 and the application of the effect associated effects associated with the second MIDI-enabled device 153 in this exemplary embodiment are regulated by the first pedal 136 of the foot controller 130. In this regard, the foot controller 130 is operably connected to the first MIDI-enabled device 151 and the second MIDI-enabled device 153, such that the foot controller 130 communicates instructions (signals) to the first MIDI-enabled device 151 and the second MIDI-enabled device 153 which affect application of the effects associated with the first MIDI-enabled device 151 and the second MIDI-enabled device 153 to the audio signals generated by the musical instrument 150 in response to the first pedal 136 being activated and deactivated by either the computer 120 or a user. Accordingly, in this exemplary embodiment, the first pedal 136 is indirectly associated with multiple effects which manipulate the audio signal generated by the musical instrument 150.

As shown in FIG. 3, in this exemplary embodiment, the foot controller 130 is operably connected to the first MIDI-enabled device 151, and the first MIDI-enabled device 151 and the second MIDI-enabled device 153 are daisy-chained together, such that: (i) the audio signal generated from the musical instrument 150 first passes through the first MIDI-enabled device 151 to which the musical instrument 150 is directly connected and then through the second MIDI-enabled device 153 prior to reaching the amplifier 140; and (ii) instructions transmitted from the foot controller 130 based on activation and deactivation of the first pedal 136 are first directed to the first MIDI-enabled device 151 to which the foot controller 130 is directly connected and are then subsequently relayed to the second MIDI-enabled device 153 to which the foot controller 130 is not directly connected.

The nature of the instructions communicated from the foot controller 130 to the first MIDI-enabled device 151 and the second MIDI-enabled device 153 may vary depending on the nature of the two MIDI-enabled devices 151, 153 utilized to manipulate the audio signals generated by the musical instrument 150. For instance, in some embodiments and implementations in which first MIDI-enabled device 151 and the second MIDI-enabled device 153 each only have a single effect associated therewith, the foot controller 130 may be configured to communicate simple activate instructions and deactivate instructions which, respectively, cause the first MIDI-enabled device 151 and the second MIDI-enabled device 153 to transition between a state in which the single effect associated with each MIDI-enabled device 151, 153 is being applied to manipulate the audio signal and a state in which the effect associated with each MIDI-enabled device is not being applied to manipulate the audio signal. To enable the same activate instruction or deactivation instruction transmitted from the foot controller 130 to affect the operation of both the first MIDI-enabled device 151 and the second MIDI-enabled device 153, the first MIDI-enabled device 151 and the second MIDI-enabled device 153 can be assigned to the same MIDI communication channel.

Embodiments and implementations are, however, contemplated in which the first MIDI-enabled device 151 and the second MIDI-enabled device 153 may each have multiple effects and parameters associated therewith that can be applied to manipulate the audio signal generated by the musical instrument 150. For instance, in some embodiments, the first MIDI-enabled device 151 and the second MIDI-enabled device may each have an effect associated therewith that has a dynamic range (i.e., the effect can be applied at different levels). The foot controller 130 may thus, in some embodiments and implementations, be configured to communicate instructions which specify the specific effects and/or effect levels each MIDI-enabled device 151, 153 should be applied at a given time. In this regard, in some embodiments and implementations, the foot controller 130 may be configured to selectively communicate program change and/or control change messages to the first MIDI-enabled device 151 and the second MIDI-enabled device 153 based on activation and deactivation of the first pedal 136.

It should be appreciated that while two MIDI-enabled devices 151, 153 are referred to as being utilized in the communication system 100 that the communication system 100 is not limited to such configuration. Rather, embodiments in which only a single MIDI-enabled device (e.g., MIDI-enabled guitar pedal) as well as embodiments in which more than two MIDI-enabled devices (e.g., three or more MIDI-enabled guitar pedals) are utilized are also expressly contemplated herein.

Referring now to FIGS. 3 and 4, in this exemplary embodiment, the foot controller 130 is programmable such that each pedal of the foot controller 130 can be assigned to control a wide variety of MIDI-enabled devices configured to manipulate the incoming audio signal received from the musical instrument 150. As noted, in this exemplary embodiment, the first pedal 136 is assigned to control the application of the effects associated with the first MIDI-enabled device 151 and the second MIDI-enabled device 153. The second pedal 138 is assigned to control playback in the temporal grid 162 of the DAW program 126. Accordingly, in this exemplary embodiment, the foot controller 130 only includes a single control (i.e., the first pedal 136) that is associated with one or more effects for manipulating the audio signal generated by the musical instrument 150 (i.e., the effects associated with the first MIDI-enabled device 151 and the second MIDI-enabled device 153). It is appreciated, however, that while the foot controller 130 is generally described herein as including only a single control which corresponds to and can be selectively activated to apply an effect, alternative embodiments are contemplated in which the foot controller 130 includes multiple controls (pedals) that are assigned to one or more MIDI-enabled devices for manipulating the audio signal generated by the musical instrument 150 and can be selectively activated to control the operation of such MIDI-enabled devices.

Referring now again specifically to FIG. 3, in this exemplary embodiment, the first pedal 136 is operably connected to the processor 132 of the foot controller 130, such that, the first pedal 136 will communicate a signal to the processor 132 indicative of the activation state of the first pedal 136 subsequent to the first pedal 136 being activated as a result of either (i) being stepped on, or otherwise depressed by, an individual or (ii) subsequent to the computer 120 communicating an instruction (signal) causing the first pedal 136 to be activated or deactivated. As noted, the computer 120 and the foot controller 130 are thus operably connected, such that the computer 120 can selectively communicate instructions (signals) to activate and deactivate the first pedal 136. With respect to user-based activation, in this exemplary embodiment, the first pedal 136 is configured to cycle between being activated and deactivated in response to being stepped on or otherwise pressed by a user. That is, in this exemplary embodiment, the first pedal 136 can be stepped on, or otherwise depressed, once to activate the first pedal 136 and cause the foot controller 130 to communicate instructions which cause the first MIDI-enabled device 151 and the second MIDI-enabled device 153 to manipulate the audio signal from the musical instrument 150. The first pedal 136 can be stepped on, or otherwise depressed again, to deactivate the first pedal 136 and to cause the foot controller 130 to communicate instructions which cause the first MIDI-enabled device 151 and the second MIDI-enabled device 153 to stop manipulating the audio signals generated from the musical instrument 150.

Referring now again to FIGS. 3 and 4, the foot controller 130 is operably connected to the computer 120, such that, in response to the second pedal 138 being stepped on (or otherwise engaged) by the user, either a first (or deactivation signal) signal or a second (activation) signal is communicated from the foot controller 130 to the computer 120. When received and processed by the computer 120, the deactivation signal causes the computer 120 to stop playback in the temporal grid 162. When received and processed by the computer 120, the activation signal causes the computer 120 to restart playback in the temporal grid 162 after being stopped in response to the deactivation signal. In this exemplary embodiment, the second pedal 138 is configured to cycle between transmitting a deactivation signal and an activation signal in response to being pressed by a user. That is, the second pedal 138 can be pressed once to cause the computer 120 to stop playback in the temporal grid 162 and pressed again to cause the computer 120 to restart playback in the temporal grid 162. In this regard, the second pedal 138 may thus be characterized as a “playback control” of the foot controller 130.

Referring now again specifically to FIG. 3, as shown, in this exemplary embodiment, the foot controller 130 is also operably connected to the computer 120 and the amplifier 140, such that the foot controller 130 can receive display change information from the computer 120 and the amplifier 140, which, when processed by the foot controller 130, causes the display 137 of the foot controller 130 to change. Display change information received from the computer 120 may include bar/meter count, markers, tempo adjustments made within the DAW program 126. Display change information received from the amplifier 140 may include tempo information or the output volume of the amplifier 140.

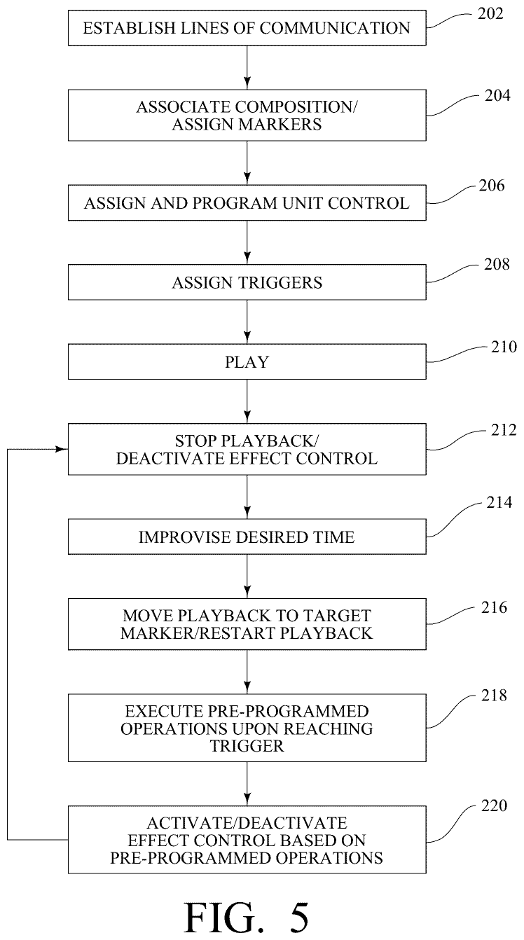

FIG. 5 is an exemplary method for adapting pre-programmed effects to a musical performance using the communication system 100 described above with reference to FIGS. 3 and 4.

Referring now to FIGS. 3-5, in the exemplary method, the computer 120, the foot controller 130, and the amplifier 140 of the communications system 100 are operably connected in a manner consistent with that described above with reference to FIG. 3, as indicated by block 202 in FIG. 5. As indicated by block 204 in FIG. 5, to associate the musical composition intended to be played during a live musical performance with the temporal grid 162, a user inserts identifiers 163a, 163b, 163c corresponding to the beginning of different parts of the composition (e.g., intro, verse, chorus, bridge, etc.) to be performed into the temporal grid 162 and markers 165a, 165b, 165c at desired time points along the temporal grid 162 to which the point of playback 161 can be selectively moved to. Association of the identifiers 163a, 163b, 163c and markers 165a, 165b, 165c with the temporal grid 162 is achieved via user interaction with the graphical user interface 160. In this exemplary implementation, the markers 165a, 165b, 165c are inserted at substantially the same time points along the temporal grid 162 as the identifiers 163a, 163b, 163c. Of course, in alternative implementations, the markers 165a 165b, 165c may be inserted before an identifier 163a, 163b, 163c, after an identifier 163a, 163b, 163c, and/or between multiple identifiers 163a, 163b, 163c so that the point of playback 161 can be moved to portions of the composition which do not perfectly align with the beginning of a part of the musical composition.

Referring still to FIGS. 3-5, after the musical composition is associated with the temporal grid 162, a unit control 162a-1621 of the temporal grid 162 is assigned for each control of the foot controller 130 that is assigned to one or more MIDI-enabled devices 151, 153 configured to manipulate the audio signals generated by the musical instrument 150. Each assigned unit control 162a-1621 is then programmed to indicate at what points during playback in the temporal grid 162 the control corresponding to the assigned unit control 162a-1621 should be activated and deactivated, as indicated by block 206 in FIG. 5. In this exemplary embodiment, as the foot controller 130 only includes a single control (i.e., the first pedal 136) that corresponds to an effect that can be selectively applied, only a single unit control, which, in this case, is the first unit control 162a of the temporal grid 162, is assigned. Of course, in alternative embodiments and implementations in which the foot controller 130 includes additional controls for regulating the effects applied by additional MIDI-enabled devices, an additional unit control would be assigned for each additional control. For instance, if the foot controller 130 were to include twelve controls assigned to a MIDI-enabled device for manipulating the audio signal generated by the musical instrument 150, each unit control of the twelve unit controls 162a-1621 shown in FIG. 4 would be assigned to a different one of the twelve controls of the foot controller 130.

Referring now specifically to FIG. 4, in this exemplary embodiment, the first unit control 162a includes a parameter setting indicator 167 that can be manipulated to indicate when the first pedal 136 of the foot controller 130 should be activated and deactivated by the computer 120 during playback in the temporal grid 162. In other words, the parameter setting indicator 167 can be manipulated to associate one or more pre-programmed operation prompts with the temporal grid 162. In this exemplary embodiment, the first pedal 136 is activated when the parameter setting indicator 167 of the first unit control 162a is raised above a baseline 168. Accordingly, in this implementation, the parameter setting indicator 167 of the first unit control 162a is manipulated as to program the first pedal 136 to be deactivated up until slightly before the second measure of the composition (as indicated by meter bar 169), activated from approximately measure two to approximately measure four of the musical composition, and then deactivated for the remainder of the portion of the musical composition shown in FIG. 4. Again, in this exemplary embodiment and implementation, the foot controller 130 only includes a single control that corresponds to an effect (i.e., the first pedal 136), which is assigned to the first control unit 162a. As such, the remainder of the unit controls (unit controls 162b-1621) of the temporal grid 162 are unassigned in FIG. 4. It should be appreciated, however, that the unassigned controls can be manipulated in the same manner as described above with respect to the first unit control 162a once assigned to a control of the foot controller 130. To illustrate the same, the parameter setting indicator of each unassigned unit control 162b, 162c, and 162e-621 in the temporal grid 162 is also manipulated in FIG. 4 solely for purpose of explanation. However, in actuality, the parameter setting indicator of each unassigned unit control 162b-1621 would actually look similar to that of the fourth unit control 162d, in which the parameter setting indicator is not raised above the baseline of the unit control.

Referring now to FIGS. 3, 4, 5, and 6A-6C, following the assignment of the first unit control 162a to the first pedal 136 of the foot controller 130 and programming the first unit control 162a via manipulation of the parameter setting indicator 167, one or more triggers (or activation nodes) 172 are implemented into the parameter setting indicator 167, as indicated by block 208 in FIG. 5. As noted above in the discussion of the communication system 10 with reference to FIG. 1, each trigger 172 is an indicator, which when reached, by the point of playback 161, causes the computer 120 to transmit instructions (signals) to the foot controller 130 to reactivate the first pedal 136 after a period in which the playback is stopped in response to an individual engaging the second pedal 138 to communicate a deactivation signal to the computer 120 to stop playback in order to establish a period of improvisation. To facilitate the implementation of triggers 172 into the parameter setting indicator 167, in this exemplary embodiment, the plug-in defining the second software module 128 works in conjunction with first software module 127 of the DAW program 126, which, again, in this embodiment, comprises Pro Tools®, to provide an editor window 171 (FIGS. 6A-6C) and a button 170 (FIG. 3) within the graphical user interface 160 provided by the DAW program 126, which, when engaged, provides access to the editor window 171.

Referring now specifically to FIGS. 3, 4, and 6A-6C, in this exemplary embodiment, upon engaging the button 170 within the graphical user interface 160, in this implementation, a new, “Trigger Editor” graphical user interface (or editor window) 171 is generated on the display 125 of the computer 120. Once the editor window 171 is generated, the user can then select the first unit control 162a (as indicated by the bolded “1” in box 174) to modify the parameter setting indicator 167 within the first control unit 162a to include one or more triggers via user interface tool 173a (FIG. 6A). The user can then mark the locations about the parameter setting indicator 167 where triggers 172 should be implemented, as indicated by the “X”s along the parameter setting indicator 167 in pop-up window 175 in FIG. 6B, via user interface tool 173b and pop-up window 175. Finally, the user can implement the triggers 172 in the locations selected, as indicated by triggers 172 in pop-up window 177 in FIG. 6C, via user interface tool 173c. In this exemplary embodiment, the editor window 171 also includes a user interface tool 173d that enables users to edit the triggers 172 in the parameter setting indicator 167 as well as an individual control that enables users to exit the editor window 171 and return to the graphical user interface 160 containing the unit controls 162a-1621. In embodiments in which the unit controls 162b-1621 are assigned to additional controls of the foot controller 130, triggers can be implemented into the parameter setting indicator 167 of such unit controls by selecting such unit controls in the editor window 171 (FIG. 6A) and applying triggers in the same manner as described above.

Referring now again to FIGS. 3-5, after the triggers 172 are implemented into parameter setting indicator 167 of the first unit control 162a, the communication system 100 is initialized for a live performance of the musical composition associated with the temporal grid 162 to begin. At the same time the live musical performance is commenced, the playback in the temporal grid 162 is started via playback controls 164, as indicated by block 210 in FIG. 5. As the playback progresses along each assigned unit control, which, again, in this case, is only the first unit control 162a, the computer 120 will communicate signals to activate and deactivate the first pedal 136 based on the parameter setting indicator 167 within the first unit control 162a. At the point in which the individual wishes to improvise, however, the second pedal 138 of the foot controller 130 can be engaged to cause the foot controller 130 to communicate a deactivation signal to the computer 120, which, when received and processed by the computer 120, causes the computer 120 to stop the playback of the musical composition associated with the temporal grid 162. In this exemplary implementation, at the time the playback of the musical composition associated with the temporal grid 162 is stopped by the computer 120, the computer 120 also communicates instructions to the foot controller 130 which cause the first pedal 136 to be deactivated, as indicated by block 212 in FIG. 5. In this regard, the plug-in defining the second software module 128 includes instructions which, when executed by the one or more processors 122 of the computer 120, cause the computer 120 to receive and process instructions received from the second pedal 138 of the foot controller 130. It is appreciated that, if the other unit controls 162b-1621 of the temporal grid 162 were assigned to a pedal of the foot controller 130, such pedals would also be deactivated as a result of the individual's engagement with the second pedal 138. As shown in FIG. 4, in this implementation, in response to the second pedal 138 of the foot controller 130 being engaged, playback in the temporal grid 162 is stopped between the “Intro” and “Verse”, slightly before the two and one-half measure mark in the temporal grid 162, as indicated by the solid-line representation of the point of playback 161 in FIG. 4.

Referring still to FIGS. 3-5, following the user engaging the second pedal 138 to stop the playback and deactivate the first pedal 136, the individual is able to improvise for a desired period of time, without the first pedal 136 being activated and deactivated based on the parameter setting indicator 167 of the first unit control 162a, as indicated by block 214 of FIG. 5. That is, following the playback and the first pedal 136 being deactivated in response to the user's engagement of the second pedal 138, the pre-programmed operations for regulating activation and deactivation of the first pedal 136 by the computer 120 will not be applied while the user is improvising. Rather, such operations will not recommence until the individual again engages the second pedal 138 to transmit instructions to the computer 120 to restart playback in the temporal grid 162, thus indicating that the period of improvisation is over and the user would like for the pre-programmed operations regulating activation and deactivation of the first pedal 136 by the computer 120 to again come into effect. During the period of improvisation when playback is stopped, the user can activate and deactivate the first pedal 136 as desired by stepping on or otherwise physically engaging the first pedal 136. Subsequent to the user re-engaging the second pedal 138 to restart playback in the temporal grid 162 by the computer 120, the computer 120 will move the point of playback 161 from the point at which it was stopped in response to the individual's first engagement of the second pedal 138 (as indicated by the solid-line representation of the point of playback 61 in FIG. 4) to a target marker within the musical composition and restart playback, as indicated by block 216 in FIG. 5.

Referring still to FIGS. 3-5, in this implementation, subsequent to receiving instructions to restart playback from the foot controller 130 in response to the user's second engagement with the second pedal 138, the computer 120 is configured to move the point of playback 161 to the next marker 165a, 165b, 165c associated with the temporal grid 162 relative to the point where playback was stopped in response to the individual's first engagement with the second pedal 138, which, in this case, is the marker 165b corresponding to the “Verse” of the musical composition (as indicated by the broken-line representation of the point of playback 161 in FIG. 4) and restart playback from that point, as indicated by block 216 in FIG. 5. Accordingly, by advancing the point of playback 161 in this way, the user can improvise, e.g., to extend the length of the “Intro” of the musical composition beyond that reflected or accounted for in the temporal grid 162 and then enter into the next part of the musical composition, which, in this case, is the “Verse”, without the playback and the pre-programmed operations for regulating activation and deactivation of the first pedal 136 by the computer 120 falling behind where the user is in their live performance of the musical composition by simply engaging the second pedal 138. In other words, the user can selectively engage the second pedal 138 to align the point of playback 161 at a desired marker 165a, 165b, 165c that corresponds to the portion of the musical composition being played live, thus effectively adapting the pre-programmed operations for activating and deactivating the first pedal 136 within the temporal grid 162 to the live performance. In some implementations, the computer 120 may be configured to communicate instructions to the foot controller 130 which cause the first pedal 136 to be deactivated to account for instances in which the first pedal 136 was activated by the user during the period of improvisation at the same time the playback is restarted in response to the user's engagement with the second pedal 138.

Referring still to FIGS. 3-5, although movement of the point of playback 161 subsequent to the computer 120 receiving instructions from the foot controller 130 to restart playback as a result of the user's second engagement with the second pedal 138 is primarily described in this embodiment and implementation as being advancing to the next marker 165a, 165b, 165c within the temporal grid 162 relative to the point where playback was stopped in response to the individual's first engagement with the second pedal 138 (i.e., move the point of playback 161 to a next, later-in-time marker), adjustment of the point of playback 161 is not so limited. Rather, alternative embodiments and implementations are contemplated in which the DAW program 126 includes instructions, which, when executed by the one or more processors 122 of the computer 120, cause the computer 120 to, in response to receiving instructions from the foot controller 130 to restart playback, move the point of playback 161 to a marker preceding the point where playback was initially stopped. Alternative embodiments and implementations are also contemplated in which the point of playback 161 can be moved to any one of the markers 165a, 165b, 165c within the composition based on a user selection, regardless of where the point of playback 161 was initially stopped. In one such embodiment and implementation, at the time an individual engages the second pedal 138 to cause the computer 120 to restart playback of the musical composition associated with the temporal grid 162, the foot controller 130 may prompt the individual to input a selection (e.g., via engagement with the display 137, the second pedal 138, a third pedal, or other component of the foot controller 130) as to which marker 165a, 165b, 165c, the user would like for the point of playback 161 to be moved to and playback restarted at. In such embodiments and implementations, the DAW program 126 will include instructions, which, when executed by the one or more processors 122 of the computer 120, cause the computer to, in response to receiving instructions to restart playback as a result of user engagement with the second pedal 138 and input corresponding to the marker 165a, 165b, 165c selected by the user, move the point of playback 161 to the marker selected by the user. Accordingly, in some embodiments and implementations, the computer 120 may be operably connected to the foot controller 130 such that a list of the markers 165a, 165b, 165c present in the temporal grid 162 can be communicated to the foot controller 130 for display thereon and an input corresponding to the individual's marker selection can be communicated to the computer 120 from the foot controller 130 for subsequent processing.

Referring still to FIGS. 3-5, instead of the computer 120 automatically executing the pre-programmed operations in the first unit control 162a corresponding to the activation and deactivation of the first pedal 136 immediately upon playback recommencing, in this exemplary embodiment, the plug-in defining the second software module 128 causes the computer 120 to wait to execute such pre-programmed operations until the point of playback 161 reaches a trigger 172 in the parameter setting indicator 167, as indicated by block 218 in FIG. 5. Thus, depending upon where the triggers 172 are implemented along the parameter setting indicator 167 and the nature of the parameter setting indicator 167 at the point where the first trigger 172 is reached, the first pedal 136 may be reactivated (if not already activated) and, the same time playback is recommenced in response to the user's second engagement with the second pedal 138 or a period of time thereafter. In the latter case, this will create a delay in the one or more effects associated with the first pedal 136 (i.e., the effects provided by the first MIDI-enabled device 151 and the second MIDI-enabled device 153) being applied. As shown in FIG. 4, in this implementation, following the point of playback 161 being advanced and playback recommenced, there will be a slight delay before the first pedal 136 is reactivated as there is a slight gap between where the point of playback 161 is advanced and where the next trigger 172 in the parameter setting indicator 167 is located. Such delay may prove advantageous in instances where the individual needs to adjust certain settings of the computer 120, the foot controller 130, the amplifier 140, and/or the musical instrument 150 immediately following the period of improvisation. In instances where some or all of the other unit controls 162b-1621 are also assigned to a control of the foot controller 130, the pre-programmed operations of such unit controls 162b-1621 will be affected in the same manner as described above.

Referring still to FIGS. 3-5, after the first trigger 172 is reached by the point of playback 161 after playback is restarted and the pre-programmed operations regulating activation and deactivation of the first pedal 136 by the computer 120 are recommenced, the computer 120 will continue to transmit instructions to the foot controller 130 which activate and deactivate the first pedal 136 based on the parameter setting indicator 167 of the first unit control 162a without regard for any subsequent triggers 172 until the point of playback 161 reaches the end of the temporal grid 162 or the second pedal 138 is again engaged again by user to stop playback, as indicated by block 220 in FIG. 5. In instances where the second pedal 138 is engaged again by the user before the point of playback 161 reaches the end of the temporal grid 162, the steps corresponding to blocks 212, 214, 216, 218, and 220 may be repeated.

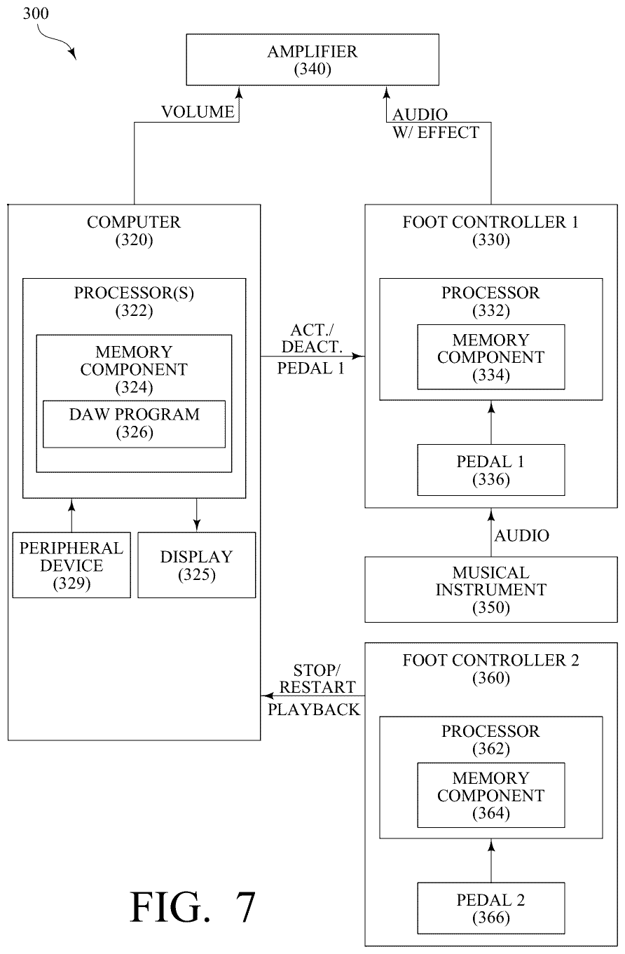

FIG. 7 is a diagram showing a second exemplary embodiment of the communication system 10 of FIG. 1. As shown, in this exemplary embodiment, the communication system 300 generally includes the same components as the communication system 100 described above with reference to FIG. 3. In this regard, the communication system 300 includes: a computer 320, including one or more processors 322 and a memory component 324 on which a DAW program 326 is stored, a display 325, and one or more peripheral devices 329; an amplifier 340; and a musical instrument 350, which include the same features of and provide the same functionality as the corresponding system components of the communication system 100 described above with reference to FIG. 3. However, unlike the communication system 100 shown in FIG. 3, in this exemplary embodiment, the communication system 300 includes two separate foot controllers: a first foot controller 330, which includes a first pedal 336 that defines the first control of the communication system 300; and a second foot controller 360, which includes a second pedal 366 defining the second control of the communication system 300.

Referring still to FIG. 7, in this exemplary embodiment, the first foot controller 330 is a MIDI-enabled foot controller, such as a Boss SY-300 Advanced Guitar Synth Pedal distributed by, e.g., Sweetwater Sound of Fort Wayne, Indiana. Unlike the communication system 100 described above with reference to FIG. 3, the controller including the first pedal 336 (i.e., the first foot controller 330) in this exemplary embodiment is operably connected to the musical instrument 350, such that audio signals generated by the musical instrument 350 are directed to the first foot controller 330. Instead of indirectly manipulating the audio signal generated by the musical instrument 350 by affecting the operation of one or more MIDI-enabled devices like in the communication system 100 of FIG. 3, in this exemplary embodiment, the first foot controller 330 directly manipulates the audio signal received from the musical instrument 350 prior to the audio signal reaching the amplifier 340. In other words, the first pedal 336 can be selectively activated to apply one or more effects associated therewith to directly manipulate an audio signal received by the musical instrument 350 and affect the audio ultimately output by the amplifier 340. Like the communication system 100 described above with reference to FIG. 3, the first pedal 336 can be selectively activated by either: (i) the computer 320 based on pre-programmed operations associated with a temporal grid provided by execution of the DAW program 326; or (ii) by a user by stepping on or otherwise depressing the first pedal 336. The first foot controller 330 includes a processor 332 for executing instructions stored on a memory component 334 operably connected to the processor 332, including instructions which cause the first controller 330 to activate and deactivate the first control 336 in response to activation and deactivation instructions (signals) received from the computer 320.

Referring still to FIG. 7, in this exemplary embodiment, the second foot controller 360 may be any foot controller which can be operably connected to the computer 320 and communicate playback activation and deactivation instructions (signals) that can be received and processed by the computer 320. The second foot controller 360 includes a processor 362 for executing instructions stored on a memory component 364 operably connected to the processor 362, including instructions which cause the second foot controller 360 to selectively communicate instructions (signals) to the computer 320 to stop playback of a musical composition associated with a temporal grid provided by execution of the DAW program 326 and instructions (signals) to the computer 320 to restart playback of the musical composition associated with the temporal grid based on user engagement with the second pedal 366. Accordingly, when the communication system 300 is in use, a user can selectively engage the second pedal 366 to adapt the pre-programmed operations corresponding to activation and deactivation of the first control 336 to a live performance in the same manner as with the communication system 100 described above with reference to FIG. 3.

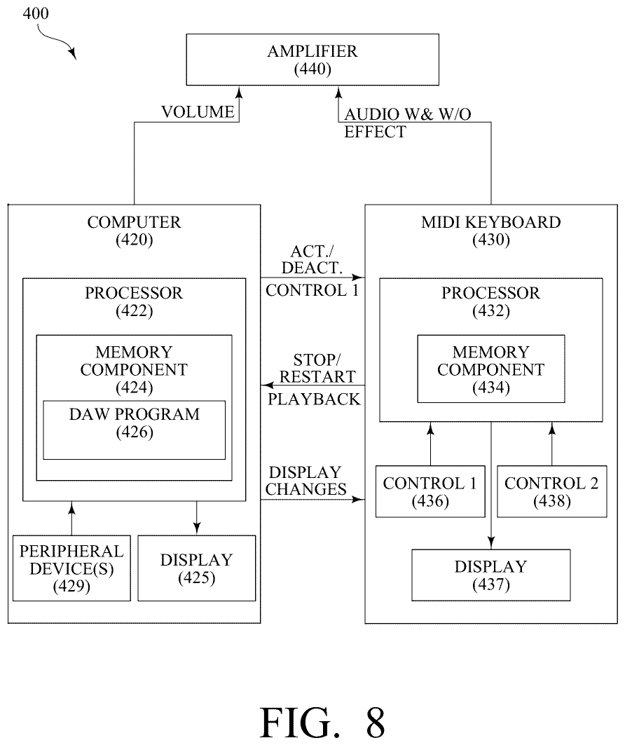

FIG. 8 is a diagram showing a third exemplary embodiment of the communication system 10 of FIG. 1. As shown, in this exemplary embodiment, the communication system 400 generally includes the same components as the communication system 100 described above with reference to FIG. 3. In this regard, the communication system 400 includes: a computer 420, including one or more processors 422 and a memory component 424 on which a DAW program 426 is stored, a display 425, and one or more peripheral devices 429; an amplifier 440; and a single controller, which in this case, comprises a MIDI Keyboard 430. The computer 420, including its respective components, and the amplifier 440 include the same features and provide the same functionality as the computer 120, including its respective components, and the amplifier 140 of the communication system 100 described above with reference to FIGS. 3 and 4. The MIDI Keyboard 430 is also similar to the foot controller 130 of the communication system 100 described above with reference to FIG. 3 in that the MIDI Keyboard 430 also includes: a first control 436; a second control 438; a display 437; and a processor 432 for executing instructions stored on a memory component 434. The memory component 434 includes instructions which cause the MIDI keybaord 430 to activate and deactivate the first control 436 in response to instructions (signals) received from the computer 420 to affect the audio output by the amplifier 440, and instructions which cause the MIDI Keyboard 430 to selectively communicate instructions (signals) to the computer 420 to stop playback of a musical composition associated with a temporal grid provided by execution of the DAW program 426 and instructions (signals) to the computer 420 to restart playback of the musical composition associated with the temporal grid based on user engagement with the second control 438.

Referring still to FIG. 8, unlike the foot controller 130 of the communication system 100 described above with reference to FIG. 3, however, in this exemplary embodiment, the MIDI keyboard 430 is configured to generate both sounds (i.e., audio signals) that can be emitted by the amplifier 440 as audio and MIDI data that can be transmitted to the computer 420 for subsequent processing. Accordingly, because the MIDI keyboard 430 in this exemplary embodiment is capable of producing audio signals, and, in this regard, is a musical instrument in and of itself, neither an external musical instrument to initially produce an audio signal nor one or more MIDI-enabled devices separate from the MIDI keyboard 430 to subsequently manipulate such audio signal is needed. One suitable MIDI keyboard which may be utilized in the communication system 400 is the Korg Keystage 49-key MIDI Keyboard Controller, manufactured and distributed by KORG U.S.A. Inc. of Melville, New York. In this exemplary embodiment, the MIDI Keyboard is directly connected to the amplifier 440, such that the keys and/or certain other controls of the MIDI keyboard can be engaged (or played) by the user to transmit audio signals to the amplifier 440. While playing the MIDI keyboard 430, the computer 420 can communicate instructions (signals) to activate and deactivate the first control 436 the MIDI keyboard 430, which may correspond to a key, button, or other control of the MIDI keyboard 430 which has one or more effects associated therewith or assigned thereto. When the first control 436 is activated, the one or more effects associated with the first control 436 are applied to the audio signal transmitted from the MIDI keyboard 430 to the amplifier 440. The second control 438 of the MIDI keyboard 430 can likewise correspond to a key, button, or other control of the MIDI keyboard 430 which can be selectively engaged by the user to communicate instructions (signals) to the computer 420 to stop and restart playback of the musical composition associated with the temporal grid provided by execution of the DAW program 426.

Accordingly, when the communication system 400 is in use, a user can selectively engage the second control 438 to adapt the pre-programmed operations corresponding to activation and deactivation of the first control 436 to a live performance in the same manner as with the communication system 100 described above with reference to FIG. 3.

It is appreciated that the musical composition can be associated with a temporal grid provided by execution of a DAW program and the temporal grid mapped with pre-programmed operation prompts within the communication systems 300, 400 described above with reference to FIGS. 7 and 8 in the same or similar fashion as the communication system 100 described above with reference to FIG. 3.

Although the various communication systems disclosed herein are primarily described in the context of either an external input device, such as a musical instrument, or a controller of the one or more controllers including the first control being responsible for generating an audio signal that is subsequently transmitted to an output device, alternative embodiments in which the electronic device executing the DAW program is responsible for generating the audio signal are also contemplated herein. In this regard, in some alternative embodiments, execution of the DAW program may enable the electronic device to serve as a virtual instrument which can transmit audio signals to the output device based on activation and deactivation of the first control of the one or more controllers of the communication system.

Furthermore, although the various communications disclosed herein are primarily described herein in the context of adapting pre-programmed effects or operations relating to the audio ultimately output by an output device, it should be appreciated that the systems and techniques described herein may be similarly employed to adapt pre-programmed effects or operations relating to visual output as well. In this regard, communication system embodiments in which the output device is configured to emit light which can be manipulated (e.g., turned on, turned off, moved, dimmed, brightened, pulsed, etc.) based on activation and deactivation of the first control are also complemented herein. For instance, in some embodiments, the output device may comprise a light, such as a stage light configured to emit and/or manipulate light in response to a signal received from a controller in response to activation of a first control, either in response to operations carried out by a computer or other electronic device based on pre-programmed operation prompts or by a user engaging the first control. Such stage lights may include, but are not necessarily limited to, ellipsoidal reflector spotlights, parabolic reflector light fixtures, Fresnel light fixtures, and moving head light fixtures. In such embodiments, execution of the operations corresponding to pre-programmed operation prompts by the computer can be regulated by user engagement with a second control in the manner described above.

Although the first control of the various communication systems disclosed herein are sometimes described in the context of being activated to manipulate an input audio and/or visual signal prior to the signal reaching the output device, alternative embodiments in which the first control can be activated to affect the audio output and/or visual output emitted by the output device by virtue of controlling certain operations of the output device of the communication system are also contemplated herein. For instance, in some embodiments, a controller including the first control of the communication system may be operably connected to an amplifier, such that, in response to the first control being activated, the controller communicates instructions (signals) which cause the amplifier to increase or decrease the volume of the audio emitted thereby or instructions (signals) which cause the amplifier to activate one or more effects (e.g., distortion, delay, tremolo) programmed thereon.

The various communication systems disclosed herein, or certain components thereof, can also serve as subsystems of a larger communication system for adapting pre-programmed effects to a musical performance involving multiple individuals playing the same musical composition. Accordingly, the present disclosure also includes communication systems for adapting pre-programmed effects to a live musical performance which include multiple communication systems consistent with those described above.

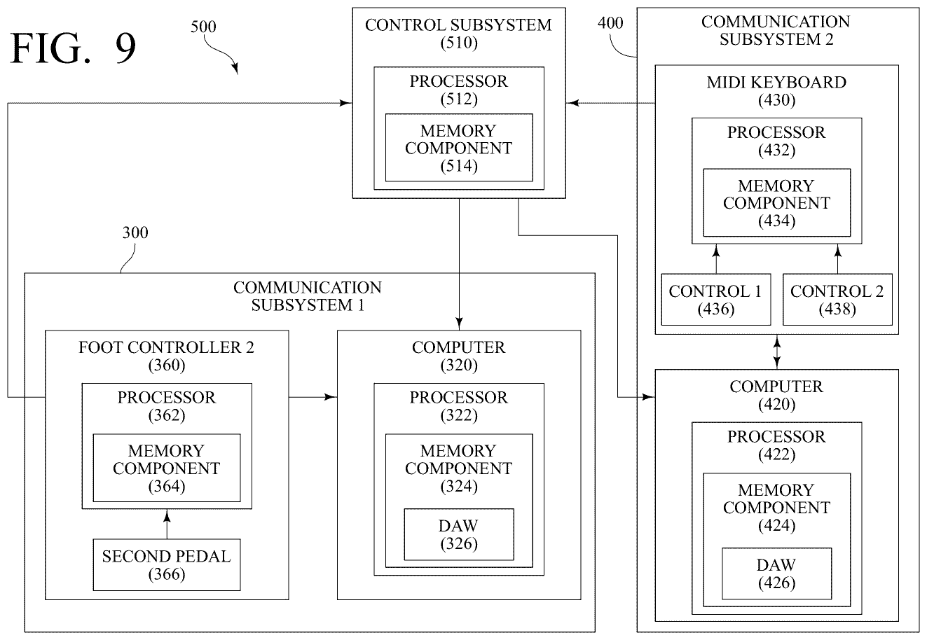

Referring now to FIG. 9, an exemplary communication system for adapting pre-programmed effects to a live musical performance involving multiple individuals playing the same musical composition (or communication system) 500 includes: a first communication subsystem for selectively applying pre-programmed effects during a live musical performance; a second communication subsystem for selectively applying pre-programmed effects during a live musical performance; and a control subsystem 510. The control subsystem 510 is configured to regulate playback in a temporal grid provided by execution of a DAW program within both the first communication subsystem and the second communication subsystem. Specifically, the control subsystem 510 is configured to synchronize playback of the musical composition in the first communication subsystem and the second communication subsystem to ensure the pre-programmed effects applied by each respective communication subsystem at a given time, if any, correspond to the same portion of the musical composition, as further discussed below.

Referring still to FIG. 9, in this exemplary embodiment, the first communication subsystem and the second communication subsystem are defined by the communication system 300 described above with reference to FIG. 7 and the communication system 400 described above with reference to FIG. 8, respectively. Accordingly, the first communication subsystem includes each of the components of the communication system 300 described above with reference to FIG. 7; however, for clarity in the drawings, only certain components of the communication system 300 are shown in FIG. 9. Likewise, the second communication subsystem includes each of the components of the communication system 400 described above with reference to FIG. 8; however, for clarity in the drawings, only certain components of the communication system 400 are shown in FIG. 9. The first communication subsystem can thus be used to associate the musical composition with a temporal grid provided by execution of a DAW program, implement pre-programmed operation prompts in the temporal grid, and regulate the application of pre-programmed effects corresponding to the pre-programmed operation prompts during a first individual's performance of the musical composition in the same manner as the communication system 300 described above with reference to FIG. 7. Similarly, the second communication subsystem can thus be used to associate the musical composition with a temporal grid provided by execution of a DAW program, implement pre-programmed operation prompts in the temporal grid, and regulate the application of pre-programmed effects corresponding to the pre-programmed operation prompts during a second individual's performance of the musical composition in the same manner as the communication system 400 described above with reference to FIG. 8.

Referring still to FIG. 9, the control subsystem 510 includes one or more processors 512 for executing instructions stored on a memory component 514 or other computer-readable medium operably connected to the one or more processors 512 to perform the various operations of the control subsystem 510 described herein. As shown, the control subsystem 510 is operably connected to both the first communication subsystem and the second communication subsystem, such that the control subsystem 510 can receive instructions (signals) from and communicate instructions (signals) to both the first communication subsystem and the second communication subsystem. More specifically, in this exemplary embodiment, the control subsystem 510 is operably connected to the second foot controller 360 and the computer 320 of the first communication subsystem, such that: (i) the second foot controller 360 communicates instructions (signals) to the control subsystem 510 for subsequent processing in response to the second pedal 366 being engaged by a first individual; and (ii) the control subsystem 510 can communicate certain instructions (signals) to the computer 320 of the first communication subsystem to regulate playback of the musical composition associated with the temporal grid provided by execution of the DAW program 326 in the first communication subsystem.

Similarly, in this exemplary embodiment, the control subsystem 510 is also operably connected to the MIDI keyboard 430 and the computer 420 of the second communication subsystem, such that: (i) the MIDI keyboard 430 communicates instructions (signals) to the control subsystem 510 for subsequent processing in response to the second control 438 being engaged by a second individual; and (ii) the control subsystem 510 can communicate certain instructions (signals) to the computer 420 of the second communication subsystem to regulate playback of the musical composition associated with the temporal grid provided by execution of the DAW program 426 in the second communication subsystem.

Referring still to FIG. 9, when the communication system 500 is in use, the second pedal 366 of the second foot controller 360 and the second control 438 of the MIDI keyboard 430 can be selectively engaged by individuals during a live performance of the musical composition to regulate playback in the first communication subsystem and the second communication subsystem, respectively, in the manner described above with reference to the communication systems 300, 400 of FIGS. 7 and 8. Upon the second pedal 366 of the second foot controller 360 being engaged a first time, the second foot controller 360 will communicate instructions (signals) to the control subsystem 510 indicating that playback is being stopped in the first communication subsystem. In response to receiving such instructions, the control subsystem 510 communicates instructions (signals) to the computer 420 of the second communication subsystem which cause playback within the second communication subsystem to stop. Accordingly, the second pedal 366 of the second foot controller 360 can be engaged a first time to establish a period of improvisation for both an individual associated with the first communication subsystem and an individual associated with the second communication subsystem. Upon the second pedal 366 of the second foot controller 360 being engaged a second time to restart playback, and thus effectively end the period of improvisation, the second foot controller 360 will communicate instructions (signals) to the control subsystem 510 indicating that playback is being moved and restarted at a particular time point (i.e., a time point associated with a particular marker) in the temporal grid of the first communication subsystem. In response to receiving such instructions, the control subsystem 510 communicates instructions (signals) to the computer 420 of the second communication subsystem which cause playback within the second communication subsystem to be moved to and restarted at a corresponding time point in the temporal grid of the second communication subsystem, thus effectively synchronizing playback within the first communication subsystem and the second communication subsystem. Alternatively, the second control 438 of the MIDI keyboard 430 can be engaged following the first engagement of the second pedal 366 of the second foot controller 360 to end the period of improvisation and communicate instructions to the control subsystem 510 which cause the control subsystem 510 to synchronize playback in the temporal grids of the first communication subsystem and the second communication subsystem.

Referring still to FIG. 9, upon the second control 438 of the MIDI keyboard 430 being engaged a first time, the MIDI keyboard 430 will communicate instructions (signals) to the control subsystem 510 indicating that playback is being stopped in the second communication subsystem. In response to receiving such instructions, the control subsystem 510 communicates instructions (signals) to the computer 320 of the first communication subsystem which cause playback within the first communication subsystem to stop. Accordingly, the second control 438 of the MIDI keyboard 430 can be engaged a first time to establish a period of improvisation for both an individual associated with the first communication subsystem and an individual associated with the second communication subsystem. Upon the second control 438 of the MIDI keyboard 430 being engaged a second time to restart playback, and thus effectively end the period of improvisation, the MIDI keyboard 430 will communicate instructions (signals) to the control subsystem 510 indicating that playback is being moved and restarted at a particular time point (i.e., a time point associated with a particular marker) in the temporal grid of the second communication subsystem. In response to receiving such instructions, the control subsystem 510 communicates instructions (signals) to the computer 320 of the first communication subsystem which cause playback within the first communication subsystem to be moved to and restarted at a corresponding time point in the temporal grid of the first communication subsystem, thus effectively synchronizing playback within the first communication subsystem and the second communication subsystem. Alternatively, the second pedal 366 of the second foot controller 360 can be engaged following the first engagement of the second control 438 of the MIDI keyboard 430 to end the period of improvisation and communicate instructions to the control subsystem 510 which cause the control subsystem 510 to synchronize playback in the temporal grids of the first communication subsystem and the second communication subsystem.

Of course, the communication system 500 for adapting pre-programmed effects to a live musical performance can be expanded to include more than two communication subsystems, where each respective communication subsystem includes some or all of the components of, and provides the same functionality as, the communication system 10 described above with reference to FIG. 1. Furthermore, while the first communication subsystem and the second communication subsystem of the communication system 500 are primarily described in the context of corresponding to the communication system 300 described above with reference to FIG. 7 and the communication system 400 described above with reference to FIG. 8, it should be appreciated that the communication system 500 is not limited to such configuration. Rather, any communication system consistent with the communication system 10 described above with reference to FIG. 1 may be utilized in the communication system 500 as communication subsystems without departing from the spirit and scope of the present disclosure.

It is appreciated that each operation performed in connection with or by the communication systems described herein can also be characterized as a method step, unless otherwise specified. Accordingly, the present disclosure is also directed to various methods of adapting pre-programmed effects to a musical performance, in which some or all of the various operations performed in connection with or by the communication systems described above correspond to a step within such methods.

One of ordinary skill in the art will recognize that additional embodiments and implementations are also possible without departing from the teachings of the present disclosure. This detailed description, and particularly the specific details of the exemplary embodiments and implementations disclosed herein, are given primarily for clarity of understanding, and no unnecessary limitations are to be understood therefrom, for modifications will become obvious to those skilled in the art upon reading this disclosure and may be made without departing from the spirit or scope of the disclosure.

What is claimed is:

1. A communication system for adapting pre-programmed effects to a musical performance:
one or more controllers, providing
a first control configured to be selectively activated to affect at least one of an audio output and a visual output to be emitted from an output device operably connected to a controller of the one or more controllers including the first control, and
a second control configured to be selectively engaged by a user;
one or more processors operably connected to the one or more controllers; and
memory storing instructions, which, when executed by the one or more processors, cause the one or more processors to
(i) selectively communicate instructions to activate and deactivate the first control during playback in a temporal grid of a digital audio workstation (DAW) program based on pre-programmed operation prompts associated with the temporal grid,
(ii) stop the playback at a first time point in the temporal grid, subsequent to receiving an instruction from the one or more controllers indicative of a first engagement of the second control,
(iii) move the playback to a second time point in the temporal grid that is different than the first time point, subsequent to receiving an instruction from the one or more controllers indicative of a second engagement of the second control,
(iv) restart the playback at the second time point, and
(v) recommence selective communication of instructions to activate and deactivate the first control based on the pre-programmed operation prompts associated with the temporal grid upon the playback reaching a trigger associated with a predetermined time point in the temporal grid, with the predetermined time point occurring at or following the second time point in the temporal grid.

2. The communication system of claim 1, wherein the one or more processors and the memory are components of an electronic device, and
wherein the electronic device further includes a display operably connected to the one or more processors, and
wherein the memory further includes instructions, which, when executed by the one or more processors, cause the one or more processors to (vi) display one or more graphical user interfaces of the DAW program.

3. The communication system of claim 2, wherein the predetermined time point in the temporal grid corresponds to a time point selected by the user,
wherein the one or more graphical user interfaces includes at least one graphical user interface including one or more user interface tools for associating the trigger with the temporal grid, and
wherein the memory further includes instructions, which, when executed by the one or more processors, cause the one or more processors to (vii) associate the trigger with the predetermined time point in the temporal grid based on user interaction with the one or more user interface tools.

4. The communication system of claim 1, wherein the predetermined time point occurs after the second time point in the temporal grid.

5. The communication system of claim 4, wherein there are one or more pre-programmed operation prompts for at least one of activating the first control and deactivating the first control associated with a time period of the temporal grid occurring between the second time point and the trigger.

6. The communication system of claim 1, wherein a controller of the one or more controllers providing the first control is a musical instrument digital interface (MIDI) controller.

7. The communication system of claim 6, wherein the MIDI-controller is indirectly connected to the output device via one or more MIDI-enabled devices.

8. The communication system of claim 1, wherein the one or more controllers includes a controller including both the first control and the second control.

9. The communication system of claim 8, wherein the controller including both the first control and the second control is a pedalboard including a first pedal defining the first control and a second pedal defining the second control.

10. The communication system of claim 1, wherein the one or more controllers includes a first controller including the first control and a second controller including the second control.

11. The communication system of claim 1, wherein the one or more controllers includes a controller including both the first control and the second control, and
wherein the controller including both the first control and the second control is a keyboard configured to generate an audio signal in response to user engagement with the keyboard.

12. The communication system of claim 1, wherein the memory further includes instructions, which, when executed by the one or more processors, cause the one or more processors to (vi) communicate an instruction to deactivate the first control, subsequent to engagement of the second control, and
wherein the first control is configured to be selectively activated and deactivated to affect the at least one of the audio output and the visual output to be emitted from the output device, subsequent to user interaction with the first control during a time period between when the playback is stopped at the first time point in the temporal grid and when the playback reaches the trigger after playback is moved to the second time point in the temporal grid and recommenced.

13. The communication system of claim 1, wherein the system includes
a first communication subsystem, including
the one or more controllers,
the one or more processors, and
the memory;
a second communication subsystem, including
a second set of one or more controllers, providing
a third control configured to be selectively activated to affect at least one of an audio output and a visual output to be emitted from a second output device operably connected to a controller of the second set of one or more controllers including the third control, and
a fourth control configured to be selectively engaged by a user,
a second set of one or more processors operably connected to the second set of one or more controllers, and
a second memory storing instructions, which, when executed by the second set of one or more processors, cause the second set of one or more processors to
(vi) selectively communicate instructions to activate and deactivate the third control during playback in a second temporal grid of a second digital audio workstation (DAW) program based on pre-programmed operation prompts associated with the second temporal grid,
(vii) stop the playback at a first time point in the second temporal grid, subsequent to a first engagement of the fourth control,
(viii) move the playback to a second time point in the second temporal grid that is different than the first time point in the second temporal grid, subsequent to a second engagement of the fourth control,
(ix) restart the playback at the second time point in the second temporal grid, and
(x) recommence selective communication of instructions to activate and deactivate the third control based on the pre-programmed operation prompts associated with the second temporal grid upon the playback reaching a trigger associated with the second temporal grid at a predetermined time point in the second temporal grid, with the predetermined time point in the second temporal grid occurring at or following the second time point in the second temporal grid; and
a control subsystem, including
a third set of one or more processors operably connected to the first communication subsystem and the second communication subsystem, and
a third memory storing instructions, which, when executed by the third set of one or more processors, cause the third set of one or more processors to
(xi) selectively communicate an instruction to the first communication subsystem to synchronize the playback in the temporal grid of the DAW program of the first communication subsystem with the playback in the second temporal grid of the second DAW program of the second communication subsystem, subsequent to the fourth control being engaged, and
(xii) selectively communicate an instruction to the second communication subsystem to synchronize the playback in the second temporal grid of the second DAW program of the second communication subsystem with the playback in the temporal grid of the DAW program of the first communication subsystem, subsequent to the second control being engaged.

14. A method for adapting pre-programmed effects to a musical performance, the method implemented by one or more processors and comprising:
selectively communicating instructions for activating and deactivating a first control to a controller including the first control during playback in a temporal grid of a digital audio workstation (DAW) program based on pre-programmed operation prompts associated with the temporal grid;
receiving a first instruction from a controller including a second control;
stopping the playback at a first time point in the temporal grid subsequent to receiving the first instruction from the controller including the second control, with stoppage of the playback ceasing the communication of instructions for activating and deactivating of the first control;
receiving a second instruction from the controller including the second control;
moving the playback to a second time point in the temporal grid that is different than the first time point subsequent to receiving the second instruction from the controller including the second control;
restarting the playback at the second time point in the temporal grid; and
recommencing selectively communicating instructions activating and deactivating the first control in accordance with the pre-programmed operation prompts associated with the temporal grid, subsequent to the restarted playback reaching a trigger associated with a predetermined time point in the temporal grid occurring at or following the second time point in the temporal grid.

15. The method of claim 14, wherein the one or more processors are components of an electronic device including a display operably connected to the one or more processors, and the method further comprising
displaying one or more graphical user interfaces of the DAW program.

16. The method of claim 15, wherein the one or more graphical user interfaces include at least one graphical user interface including one or more user interface tools for associating the trigger with the temporal grid, and the method further comprising
associating the trigger with the temporal grid based on user interaction with the one or more user interface tools.

17. The method of claim 14, wherein the trigger occurs after the second time point in the temporal grid.

18. The method of claim 14, wherein the first control and the second control are components of one or more controllers operably connected to the one or more processors, and
wherein the second control is configured to (i) transmit the first instruction to the one or more processors subsequent to a first user engagement with the second control and (ii) to transmit the second instruction to the one or more processors subsequent to a second user engagement with the second control.

19. The method of claim 14, wherein the controller including the first control and the controller including the second control are the same controller.

20. A non-transitory computer-readable medium storing instructions for execution by one or more processors, the non-transitory computer-readable medium including instructions for:
selectively communicating instructions for activating and deactivating a first control of a controller operably connected to the one or more processors during playback in a temporal grid of a digital audio workstation (DAW) program based on pre-programmed operation prompts associated with the temporal grid;
stopping the playback at a first time point in the temporal grid, subsequent to the one or more processors receiving a first instruction from a controller including a second control;
moving the playback to a second time point in the temporal grid that is different than the first time point, subsequent to the one or more processors receiving a second instruction from the controller including the second control;
restarting the playback at the second time point; and
recommencing selectively communicating instructions activating and deactivating the first control in accordance with the pre-programmed operations associated with the temporal grid, subsequent to the restarted playback reaching a trigger associated with a pre-determined time point in the temporal grid occurring at or following the second time point in the temporal grid.
